(19) United States
(12) Patent Application Publication
(10) Pub. No.: US 2025/0052372 A1
(43) Pub. Date: Feb. 13, 2025

(54) UTILIZING PIPELINE CO2 FOR ENERGY STORAGE

(71) Applicant: Lummus Technology LLC, Bloomfield, NJ (US)

(72) Inventors: Daniel FERNALD, Bloomfield, NJ (US); Melanie O’SULLIVAN, Bloomfield, NJ (US)

(21) Appl. No.: 18/797,813

(22) Filed: Aug. 8, 2024

Related U.S. Application Data
(60) Provisional application No. 63/518,494, filed on Aug. 9, 2023.

(51) Int. Cl. F17C 7/00; B01D 53/26; F17C 5/06

(52) U.S. Cl. CPC F17C 7/00; B01D 53/261; F17C 5/06; B01D 2256/22; B01D 2257/80; B01D 2259/4009; F17C 2221/013; F17C 2227/0157; F17C 2227/0316; F17C 2227/0325; F17C 2265/07

(57) ABSTRACT

A system includes a discharge subsystem with at least one expander stage operable to expand and heat a high-pressure CO2 stream from an existing CO2 pipeline to generate power and output a low-pressure CO2 stream to a storage media. A charge subsystem includes at least one compression stage operable to compress and cool the low-pressure CO2 stream from the storage media and provide a recycle high-pressure CO2 stream to the existing CO2 pipeline. A thermal integration subsystem is in fluid communication with the at least one expander stage and at least one compression stage to provide heating duty and cooling duty for the heating and cooling operations, respectively. The system relies on the existing CO2 pipeline for storage of high-pressure CO2 to provide the benefits described in the disclosure. Related methods are also contemplated.

### BACKGROUND

### Technical Field

The present disclosure is generally directed to energy storage, and more specifically, but not exclusively, to utilizing pipeline carbon dioxide (“CO2”) for energy storage.

### Description of the Related Art

Recently, there has been increased research in renewable energy technology to combat climate change. One challenge associated with renewable energy is long duration energy storage. It is known that renewable energy sources are variable in the sense that they produce energy when conditions are favorable, such as when the sun is shining on solar panels or wind is blowing to spin a wind turbine, but produce less energy or no energy when conditions are less favorable. As a result, energy supply from renewable energy sources is not consistently aligned with consumer demand for energy. Thus, as renewable energy becomes more prevalent in society, long duration energy storage will become critical to balance the variation in supply from renewable energy sources with the energy needs of end consumers. Long duration energy storage presents unique challenges compared to short-term storage options.

Many existing energy storage technologies rely on extreme thermal storage, such as at very high or very low temperatures, or both. As storage times increase, the heat duties associated with these technologies will dissipate to atmosphere and become unavailable for the process. Thus, there is a constant net reduction in stored energy over time with thermal storage that makes these technologies an impractical solution for long-term storage. In some examples, existing energy storage technologies rely on specific geological features, such as underground caverns or hills and reservoirs. However, for long-term storage, the quantity of energy storage material is higher than short-term storage requirements. As a result, plant costs increase and expanding plot sizes are required to accommodate the large quantity of energy storage material needed as well as tanks and other like devices to store the energy storage material. If the storage material is not benign to the environment, the system must be closed loop and will require both charge and discharge storage, which furthers the above deficiencies and drawbacks. Relying on geological features also reduces the number and availability of possible installation locations. In some cases, potential installation locations, even if geologically suitable, are remote and not practical for transmission of the stored energy to high demand locations absent expensive transmission infrastructure upgrades.

As a result, it would be beneficial to have a technology with mild thermal storage temperatures, high energy density to reduce quantity of storage material, low-cost storage for the material, and that is not dependent on geological features so it can be built in a wide array of locations.

One prior solution is pumped storage hydropower. However, this solution requires very specific geological features. Water is pumped to the top of a hill during a charge operation. During a discharge operation, the water is sent down the hill and generates power via a turbine. Two reservoirs are required at different elevations to enable such a system. Energy density is dependent on elevation difference of reservoirs but is typically low compared to other methods and a large area of land is needed to implement such a system.

Another proposed solution is compressed air energy storage, but this solution likewise requires specific geological features. With compressed air energy storage, high-pressure air is typically stored in underground caverns and thus this solution is geographically and geologically limited, among other deficiencies.

Yet a further proposed solution is liquid air energy storage. This solution requires extreme cryogenic thermal storage to condense air. As a result of the low temperature of liquid air, the storage tanks are very expensive, and in many applications, prohibitively expensive for widespread adoption or implementation at scale. Another disadvantage of this proposed solution is that it requires extreme cryogenic thermal storage to condense the air. There are other deficiencies and drawbacks as well.

Another proposed solution is thermochemical energy storage, but the storage materials for these techniques, which may be reactants and/or products of an equilibrium reaction, are typically expensive and/or experience cyclical deactivation over time and/or would require replacing the material periodically depending on the lifetime of the material, leading to a net reduction in stored energy over time.

Recent research has also considered CO2 as a possible storage media. In some cases, systems have been developed with high-pressure storage tanks and low-pressure storage tanks for CO2. The low-pressure product may be stored as a vapor in a large dome, requiring very large volume and leading to many of the disadvantages discussed above.

Further research considers using current pressure reduction stations in a natural gas pipeline to generate power, such as by replacing control valves with turbo-expanders. A nearby power plant provides waste heat to facilitate power generation. One downside of this approach is that the installation location is limited only to locations near a waste heat source, and preferably near a power plant. The low-pressure natural gas is not stored but is directed to the user. Thus, this solution is incomplete at best.

Other approaches appear to apply the above concepts discussed with respect to natural gas pipelines to a CO2 pipeline and therefore has similar drawbacks.

In view of the above, it would be advantageous to have energy storage technology that overcomes the above deficiencies and drawbacks of existing solutions.

### BRIEF SUMMARY

The present disclosure is generally directed to using pipeline CO2 for long-term energy storage. Among other benefits described herein, the techniques of the disclosure do not require or utilize high-pressure storage of CO2. Rather, high-pressure CO2 is supplied directly from an existing pipeline. Accordingly, high-pressure storage tanks and other expensive aspects of conventional systems can be omitted, with the system generally being suitable for installation at locations along new or existing CO2 pipeline infrastructure. As there are numerous dedicated pipelines across the United States, and other countries, for conveying CO2, the techniques of the disclosure enable installation of a long duration energy storage solution at favorable locations relative to energy demand.

In some examples, when there is a deficit in power, the system operates in discharge mode. High-pressure CO2 from the pipeline is heated and expanded to generate power and subsequently condensed, subcooled, and stored. The storage may be in low-pressure storage tanks, geological configurations such as a cavern, and other suitable storage methods and devices whether relying on natural features or structures such as tanks, which may collectively be referred to as “storage media” or “storage medium.” “Subcooled” may refer to liquid CO2 being at a temperature below its normal boiling point. When there is a surplus of power, the system operates in charge mode. The low-pressure CO2 from the storage media is pumped, vaporized, superheated, and compressed before returning to the pipeline. “Superheated” may refer to heating the vaporized CO2 above its temperature of saturation. The compressor discharge provides heating for the discharge operation. Vaporization during the charge operation provides condensing duty for the discharge operation. The system operates as a fully independent system and does not rely on waste heat streams, although waste heat streams can be incorporated into the techniques described herein for additional efficiency.

Thus, the techniques discussed herein eliminate one set of storage, and particularly at least expensive and complicated high-pressure CO2 storage, by using existing CO2 pipelines for high-pressure storage. The low-pressure CO2 product is stored as a liquid, thereby reducing the associated storage volume significantly and further decreasing costs. Compared to the other forms of energy storage discussed above, the techniques of the disclosure enable the system to operate anywhere that has access to a CO2 pipeline. Thus, the techniques discussed herein do not require specific geological features or waste energy streams from other facilities. Rather, the system can operate as a fully independent system. CO2 is condensed at relatively mild temperatures compared to other substances, such as air, is readily available and inexpensive.

Additional features and advantages of the techniques of the disclosure are provided herein.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive implementations are described with reference to the following drawings, wherein like labels refer to like parts throughout the various views unless otherwise specified. The figures do not describe every aspect of the teachings disclosed herein and do not limit the scope of the claims.

FIG. 1 is a schematic diagram of an implementation of an energy storage system utilizing an existing pipeline for high pressure storage according to the present disclosure.

FIG. 2 is a schematic diagram of an implementation of an energy storage system according to the present disclosure illustrating a discharge subsystem of the energy storage system.

FIG. 3 is a schematic diagram illustrating a charge subsystem of the energy storage system of FIG. 2.

FIG. 4 and FIG. 5 are schematic diagrams of a first thermal integration subsystem and a second thermal integration subsystem, respectively, of the energy storage system of FIG. 2.

FIG. 6 is a schematic diagram of an implementation of an energy storage system according to the present disclosure illustrating first and second expansion stages of a discharge subsystem.

FIG. 7 is a schematic diagram illustrating a dryer stage and a dryer regeneration stage of the discharge subsystem of the energy storage system of FIG. 6.

FIG. 8A and FIG. 8B are schematic diagrams illustrating a third expansion stage and a low-pressure product condensation stage of the discharge subsystem of the energy storage system of FIG. 6.

FIG. 9A and FIG. 9B are schematic diagrams illustrating a charge subsystem of the energy storage system of FIG. 6.

FIG. 10 is a schematic diagram illustrating a thermal integration subsystem of the energy storage system of FIG. 6.

FIGS. 11A is a schematic diagram of an implementation of an energy storage system according to the present disclosure illustrating a discharge subsystem of the energy storage system.

FIG. 11B is a schematic diagram of a dryer regeneration subsystem of the energy storage system of FIG. 11A.

FIG. 12 is a schematic diagram of a charge subsystem of the energy storage system of FIG. 11A.

FIG. 13 is a schematic diagram of a thermal management subsystem of the energy storage subsystem of FIG. 11A.

FIG. 14 is a schematic diagram of an implementation of a charge subsystem according to the present disclosure.

### DETAILED DESCRIPTION

Persons of ordinary skill in the relevant art will understand that the present disclosure is illustrative only and not in any way limiting. Other implementations of the presently disclosed systems and methods readily suggest themselves to such skilled persons having the assistance of this disclosure.

Each of the features and teachings disclosed herein can be utilized separately or in conjunction with other features and teachings to provide energy storage devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense and are instead taught merely to describe particularly representative examples of the present teachings.

Moreover, the various features of the representative examples and the dependent claims may be combined in ways that are not specifically and explicitly enumerated to provide additional useful implementations of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples in some implementations. In some implementations, the dimensions and the shapes of the components shown in the figures are exactly to scale and intended to limit the dimensions and the shapes of the components.

The present disclosure is generally directed to providing a long-term energy storage solution utilizing compressed pipeline CO2 as the storage media. The disclosure contemplates integration of an energy storage system into existing CO2 pipeline infrastructure that eliminates independent high-pressure CO2 storage and the associated costs and other drawbacks associated with high-pressure storage by instead relying on high-pressure CO2 in the pipeline for storage. CO2 is a suitable storage medium because it is condensed at comparatively mild temperatures relative to other possible media, such as air. CO2 is also readily available based on existing CO2 production and transmission infrastructure and inexpensive.

A primary technical obstacle in designing a long-term energy storage solution is the criteria of the problem being solved. In particular, a beneficial long-term energy storage solution preferably uses an inexpensive and readily available storage material, has high energy density and low storage cost, can be located almost anywhere, does not rely on waste heat streams from other facilities, provides energy storage capacity to meet multiple days or more of consumer energy demand, and does not require extreme thermal storage. As described further below, the concepts of the disclosure enable energy storage solutions that meet or exceed the above preferred criteria. One particular benefit of the concepts of the disclosure is the use of an existing CO2 pipeline as high-pressure storage in the system. Such an arrangement enables elimination of expensive high-pressure storage tanks, reduces equipment count and capital cost, and reduces installation location plot size, among other advantages.

Another challenge with designing long-term energy storage solutions, particularly with CO2 as the storage media, is to minimize compression power consumption while also generating sufficient heating duty for the discharge process. If there are no waste heat streams available, it is important to generate heat sufficient to produce heating duty for discharge in the most efficient way possible (i.e., via compression) to maximize net power generation and round-trip efficiency. The concepts of the present disclosure overcome this technical challenge as well. In preferred examples, the heating duty is warm water, although the disclosure contemplates use of other heating mediums. Other types of heating mediums would be any chemical with a boiling point appropriate to the heat integration of the specific system (i.e., boiling point above maximum heating temperature). Such heating mediums would be a fluid with a boiling point with sufficient margin above the maximum process temperature, including, but not limited to, the following fluids: formic acid, methylcyclohexane, 1,4-dioxane, isobutyl alcohol, saturated brine, diisobutyl, peroxyacetic acid, toluene, butyl-n alcohol, 1-butanol, nitric acid, paraldehyde, n-octane, chlorobenzene, ethylene bromide, hexylamine, ethylbenzene, p-xylene, acetic acid anhydride, m-xylene, propionic acid, o-xylene, styrene, kerosene (paraffin), n-nonane, isopropylbenzene, isopropylbenzene hydroperoxide, anisole, cyclohexanone, bromobenzene, turpentine, furfurol, butyric acid n, jet fuel, fyrfuryl alcohol, n-decane, benzaldehyde, phenol, carbolic acid (phenol), aniline, iodine, dimethyl sulfate, propylene glycol, benzonitrile, ethylene glycol, glycol, water and camphor, among others. Water is the preferred option in some applications of the technology due to the cost and environmental compatibility, among other factors (i.e., high liquid density, high liquid heat capacity, etc.) The following disclosure will describe non-limiting examples that rely on warm water as the heating medium, although it is to be appreciated that the disclosure is not limited thereto. Similarly, the disclosure may describe certain non-limiting examples of cooling duty that is preferably cool water, although other cooling mediums are contemplated herein and the disclosure is not limited solely to cool water as a cooling medium. In yet further non-limiting examples where the technology seeks to maximize storage temperature, other fluids besides water, including any of those described herein and others, may be preferred.

As used herein, “discharge operation” is a broad term that refers to an operational cycle of the systems discussed herein to utilize stored potential energy to generate power. Thus, a discharge operation may be initiated in response to a determined deficit of available power or energy, such as from renewable or other sources, relative to consumer demand. The system initiates the discharge operation to satisfy the deficit so that energy supply aligns with consumer demand. A “charge operation” is likewise a broad term but refers instead to an operational cycle of the system discussed herein to store energy for subsequent power generation. A charge operation may be initiated during periods when available power or energy supply exceeds consumer demand. Thus, the system initiates the charge operation to store energy when excess energy is available. The stored energy from the charge operation can then be utilized at a different instance in a discharge operation to overcome energy deficits.

Further, the below non-limiting examples of implementations of the energy storage systems and methods reference specific temperatures, pressures, and other attributes at certain points in the system or method. It is to be appreciated that such specific examples are preferred values for implementation of the techniques herein and are provided to assist with explaining the concepts of the disclosure, but the disclosure is not limited thereto. There may be expected operational variations in the indicated values of around 5%, or perhaps more. Further, other designs of the systems and methods may utilize different attributes or values that may be more or less than the stated value. Thus, unless the context clearly dictates otherwise, any specific values provided below regarding temperature, pressure, and other attributes are construed to include an error range of plus or minus 5% with the understanding that the values may also be selected to be different from the stated value by more than 5% depending on the implementation of the systems and methods.

It is also noted that the accompanying figures are schematic illustrations that generally indicate fluid communication between various aspects of the system described herein with solid lines or dashed lines. The solid or dashed fluid communication lines should be construed broadly to include pipes, pipelines, conduits, flow lines, tubes, and the like as well as associated connectors, fasteners, valves, and other mechanical aspects of establishing fluid communication. In essence, the solid and dashed fluid communications lines should be construed to include any structure or device capable of establishing the fluid communication between aspects of the system that is described herein, regardless of whether these lines are specifically described as “conduits” and the like in the following description. In some cases, dashed lines represent communication from a measurement to a valve (i.e., an electrical instrumentation connection). Except as otherwise noted, arrows along these solid or dashed lines represent a direction of fluid flow through the system. In some implementations, the solid or dashed lines may indicate that certain aspects of the system are directly fluidly connected to each other via the fluid communication line, and in other implementations, there may be intervening structures, valves, mechanical couplings, and the like between the connected aspects of the system. Each of the individual solid or dashed lines may correspond to only a single (i.e., one) pipe, conduit, the like in practice, although the individual solid or dashed lines may also include multiple pipes, conduits, and the like, which may particularly be applicable where multiple components of the system are in communication with a common component of the system, as described further below.

As used herein, the phrase “CO2 pipeline” generally refers to large-scale infrastructure systems that are designed to carry pressurized CO2 (such as at approximately 150 bar in a non-limiting example) across many miles from an origin location to a destination location. For example, a “CO2 pipeline” of the type considered herein is generally consistent with the approximately 50 existing CO2 pipelines in the United States as of the date of the disclosure with a combined length of over 4,500 miles, and other similar systems worldwide that are now existing or contemplated in the future. Specific examples of such existing large-scale CO2 pipelines in the United States that are consistent with “CO2 pipeline” as used herein include, but are not limited to: the Permian Basin CO2 pipeline spanning 2,600 miles through Texas, New Mexico, and Colorado; the Gulf Coast CO2 pipeline spanning 740 miles through Missouri, Louisiana, and Texas; the Rocky Mountain CO2 pipeline spanning 730 miles through Colorado, Wyoming, and Montana; the Mid-Continent CO2 pipeline spanning 480 miles through Oklahoma and Kansas; and others, although smaller scale CO2 pipelines are also contemplated as being a “CO2 pipeline” of the type described herein. In sum, a CO2 pipeline does not refer to a pipe, conduit, or the like in a processing system, but rather, a transmission line that traverses large distances from an origin location to a destination location, typically in a continuous process without intervening processing or manipulation of the CO2 stream except to the extent the CO2 pipeline includes intermediate pumping stations to maintain supercritical conditions over long distances. The present disclosure also contemplates using other chemicals for the working fluid, such as ethane. The use of “ethane pipeline” herein may generally be consistent with the meaning of “CO2 pipeline” described above except for differences in the fluid and corresponding differences in the pipeline because of the different fluid properties.

Further, the concepts of the disclosure will proceed to discuss aspects for the generation of energy, typically in the form of electricity, from a pressurized CO2 stream from a CO2 pipeline, storing the resulting low-pressure CO2 following energy generation, and compressing and returning a recycle high-pressure CO2 pressure stream to the CO2 pipeline. Thus, the systems, subsystems, and other aspects described herein may be in electrical communication with an electricity grid or electricity transmission devices, among others, even if not explicitly shown in the accompanying drawings. In this way, the concepts of the disclosure “store” energy in the CO2 pipeline in the sense that the pressurized CO2 stream from the pipeline can be selectively utilized to help align renewable energy supply with consumer demand.

More specifically, the system and subsystems herein may utilize energy for operation. During periods of a determined deficit in renewable energy supply in the electrical grid relative to consumer demand, a discharge operation can be implemented. The discharge operation utilizes energy from pressurized CO2 stored in a CO2 pipeline, but this energy aside, produces more energy than it consumes. Thus, aside from the energy from the pressurized CO2 stored in the pipeline, the discharge operation is a net positive energy operation. During periods of a determined surplus in renewable energy supply in the electrical grid relative to consumer demand, a charge operation can be implemented. The charge operation utilizes or consumes energy and may not produce energy. Thus, the charge operation is a net negative energy operation. Overall, the combination of the discharge and charge operations may be a net negative for total energy use relative to total energy generation (i.e., charge operation uses more energy than produced during discharge operation), but the efficiency of the concepts of the disclosure is improved relative to other solutions. Further, utilizing CO2 for energy storage and generation has additional benefits described herein relative to prior technologies. In sum, the concepts of the disclosure help “smooth” variations in renewable energy supply so that available energy from renewable sources more closely approximates consumer demand by relying on pressurized CO2 from a CO2 pipeline.

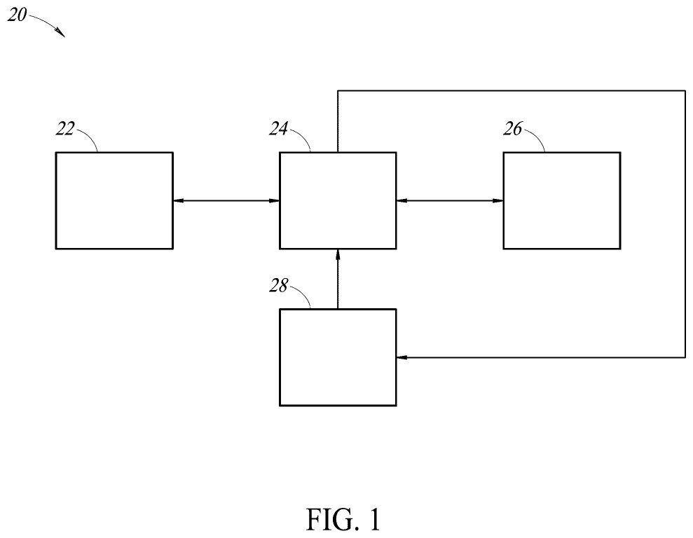

As noted above, the present disclosure contemplates utilizing a pipeline for high pressure storage. FIG. 1 illustrates an implementation of an energy storage system 20 that uses a pipeline 22 for high pressure storage to provide an overview of the concepts of the disclosure. The pipeline 22 may be a CO2 pipeline, ethane pipeline, or some other working fluid pipeline. High pressure working fluid, such as CO2, ethane, or others, is provided from the pipeline 22 to an expander/compressor 24 where the working fluid is heated and expanded to form a low-pressure product that is stored in storage media 26 in a discharge operation. The expansion of the high-pressure working fluid to form the low-pressure product may produce energy or is otherwise an energy positive operation. The discharge operation can be used to provide energy (or power) to an electric grid during periods when renewable energy supply is low or there is otherwise a demand in the electrical grid for more energy.

In a charge operation, the low-pressure product from the storage media 26 is provided back to the expander/compressor 24 where the low-pressure product is compressed and cooled to form a high-pressure product that is returned to the pipeline 22 in a fluid loop. The charge operation is a net negative energy operation and may occur when there is a surplus of energy in an electrical grid from renewable sources. The surplus of energy is used to power the operations needed to compress and cool the low-pressure product for return to the pipeline. The expander/compressor 24 may be in communication with a thermal integration subsystem 28 that provides heating and/or cooling duty for the discharge and charge operations described above. The thermal integration subsystem 28 may rely on fluids, such as water and others, as the heating and cooling duty. Alternatively, the thermal integration subsystem 28 may rely on phase change materials and/or thermal storage materials to provide the heating and cooling duty. In this way, the pipeline 22 is used for high pressure storage for energy generation with the specific features of the expander/compressor 24, storage media 26, and/or thermal integration subsystem 28 able to be optimized based on the specific project, location, cost, and further developments in the technology.

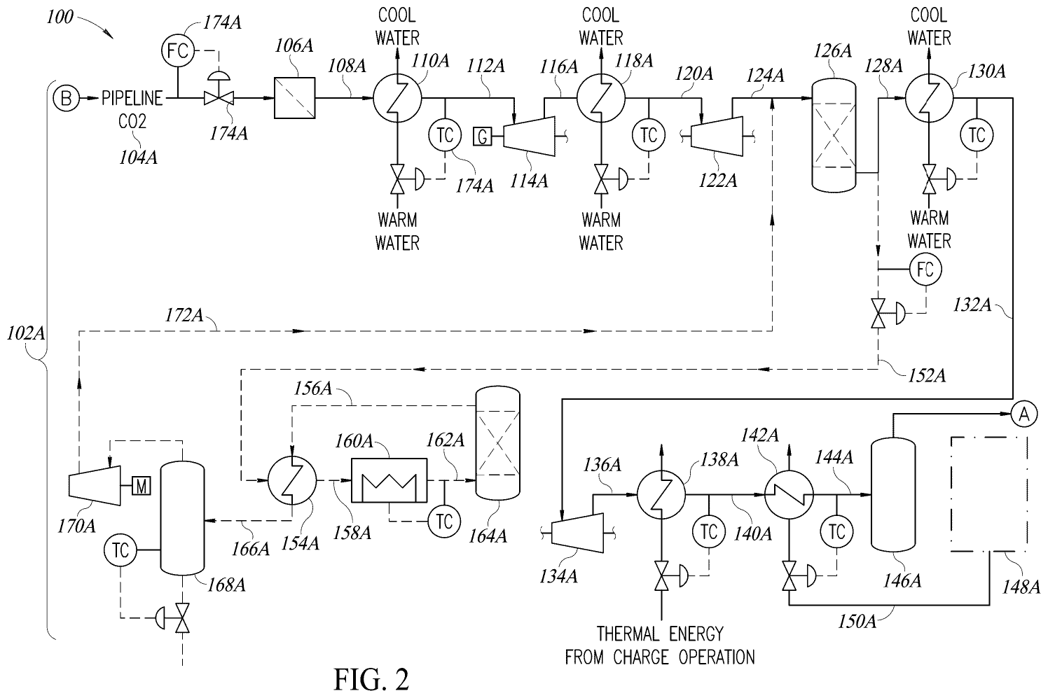

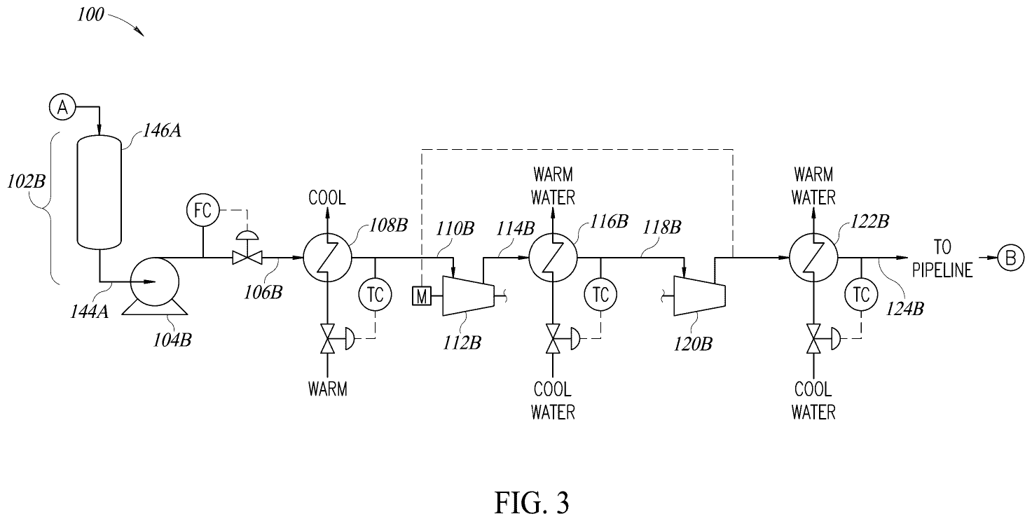

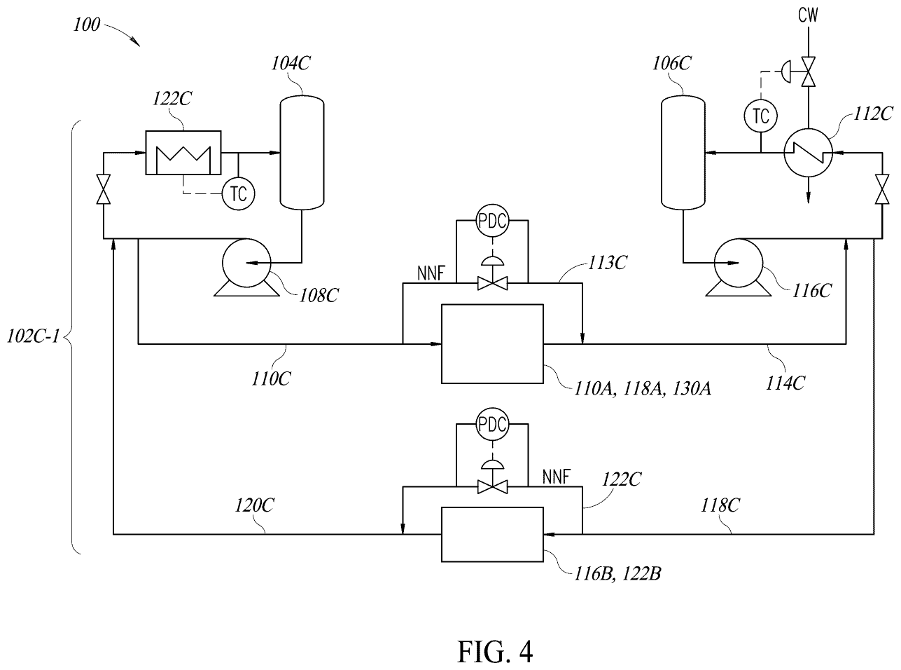

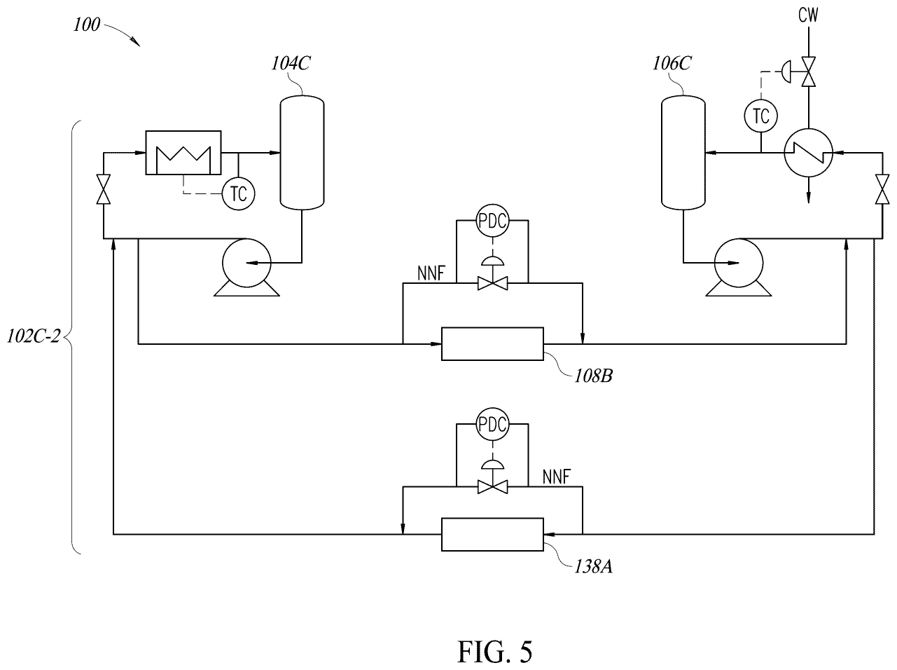

FIG. 2 is a schematic diagram of an energy storage system 100 illustrating a discharge operation of the energy storage system 100. FIG. 3 is a schematic diagram of the energy storage system 100 illustrating a charge operation. FIG. 4 and FIG. 5 are schematic diagrams of first and second thermal integration subsystems of the energy storage system 100. FIGS. 2-5 are provided to illustrate one non-limiting implementation of a system according to the techniques discussed above with reference to FIG. 1. As noted, features of the system 100 in FIGS. 2-5 may be optimized based on various factors. Although FIGS. 2-5 illustrate different aspects of the system 100, it is to be appreciated that the overall system 100 includes the features and components discussed with reference to FIGS. 2-5. Thus, the system 100 may be considered a combination of the techniques and aspects discussed with reference to FIGS. 2-5, with the discharge operation, charge operation, and thermal integration subsystems being subsystems within the broader system 100. Thus, the discharge operation may be implemented by a discharge subsystem and the charge operation may be implemented by a charge subsystem. Except as otherwise noted below, the system 100 of FIGS. 2-5 is a non-limiting example of the techniques of the disclosure and may include non-limiting examples of values, such as temperature, pressure, and others in the system to help explain the concepts of the disclosure.

Beginning with FIG. 2, illustrated therein is a discharge subsystem 102A of the system 100 that is operable to generate power using the techniques discussed below in response to an energy or power deficit. The discharge subsystem 102A is in communication with pipeline CO2 104A, which is initially at high-pressure, such as 150 bar in some non-limiting examples. The pipeline CO2 104A is first filtered to remove particles and pipeline rouge via filter 106A to produce a filtered CO2 stream 108A. The filtered CO2 108A is provided to a first preheater 110A where the filtered CO2 108A is heated to 95 degrees Celsius (“C”) with warm water, thereby producing cool water, to produce a first preheated CO2 stream 112A. The first preheated CO2 stream 112A is provided to a first expander 114A whereby the first preheated CO2 stream 112A is expanded to a first intermediate-pressure, such as 66 bar in some non-limiting examples to form a first intermediate-pressure CO2 stream 116A.

The first intermediate-pressure CO2 stream 116A is again heated to 95 degrees C. with warm water, thereby producing cool water, at a second preheater 118A to produce a second preheated CO2 stream 120A that is expanded with a second expander 122A to a second intermediate-pressure, such as 29 bar in some non-limiting examples, to form a second intermediate-pressure CO2 stream 124A. The second intermediate-pressure CO2 stream 124A is dried at a dryer 126 to produce a dried CO2 stream 128A that is provided to a third preheater 130A. The dried CO2 stream 128A is heated to 95 degrees C. at the third preheater 130A with warm water, thereby producing cool water, to produce a third preheated CO2 stream 132A that is expanded with a third expander 134A to a low-pressure, such as 13 bar in some non-limiting examples and form a low-pressure CO2 stream 136A. The low-pressure CO2 stream 136A is then condensed with a condenser 138A against cooling duty from the charge operation where the liquid CO2 is vaporized to produce a condensed CO2 steam 140A. The condensed CO2 stream 140A is subcooled, such as to 4 degrees C. in some non-limiting examples with a subcooler 142A to produce a CO2 storage stream 144A that is provided to, and stored in, one or more low-pressure CO2 storage media 146A, which may be tanks, geological configurations, and other storage systems, devices, and methods. The discharge subsystem 102A may further include a refrigerant package 148A, such as a propylene refrigerant package, that provides propylene refrigerant along conduit 150A to the subcooler 142A. Thus, in some implementations, the subcooling at the subcooler 142A takes place against propylene refrigerant from the refrigerant package 148A. The subcooler 142A is not required and may be optional in some implementations.

The discharge subsystem 102A may further utilize a portion of the CO2 from the dryer effluent, or a portion of the CO2 from the dried CO2 stream 128A output from the dryer 126A, as regeneration gas for the dryer 126A. Specifically, a regeneration gas feed 152A, which may be a portion of the dried CO2 stream 128A from the dryer 126A, may be provided to a regeneration feed exchanger 154A. The regeneration gas feed 152A is heated at the regeneration feed exchanger 154A against regeneration gas effluent 156A to form a heated regeneration gas feed 158A. The heated regeneration gas feed 158A is further heated with an electric heater 160A to form a hot regeneration gas feed 162A that is provided to a dryer 164A. The dryer 164A may be a desiccant bed 164A whereby the hot regeneration gas feed 162A removes water from the bed 164A to produce the regeneration gas effluent 156A. The regeneration gas effluent 156A is cooled against the regeneration gas feed 152A at the regeneration feed exchanger 154A to produce a cooled regeneration gas effluent 166A. The cooled regeneration gas effluent 166A is fed to a knock-out drum 168A to remove any water and compressed with a blower 170A to produce a regeneration gas 172A that is provided to an inlet of the dryer 126A. The discharge subsystem 102A may further include a variety of valves, flow control devices, temperature control devices, pressure control devices, and the like that are generally designated 174A. These devices 174A are provided to control fluid flow, temperature, and pressure, among other attributes across the discharge subsystem 102A, but are not discussed in detail to avoid obscuring concepts of the disclosure.

In some implementations, each of the expanders described above with reference to FIG. 2, such as at least first, second, and third expanders 114A, 122A, and 134A are turbo-expanders or expansion turbines. The turbo-expanders 114A, 122A, and 134A expand high-pressure gas to produce work that is used to drive a compressor or generator to produce power. In other words, the turbo-expanders 114A, 122A, and 134A produce energy as a result of the pressure differential between an incoming feed and an effluent. Although the discharge subsystem 102 is illustrated as including three turbo-expanders 114A, 122A, and 134A, it is to be appreciated that the system 100 may generally include a selected number and arrangement of turbo-expanders 114A, 122A, and 134A that may be more or less than three. Other configurations and types of power generation devices are contemplated herein for use instead of, or in addition to, the turbo-expanders 114A, 122A, and 134A, such as at least thermal generators that produce power based on the warm and cool water associated with the preheaters 110A, 118A, 130A.

Thus, the discharge subsystem 102A produces power from high-pressure CO2 provided from an existing pipeline (i.e., pipeline CO2 104A) through sequential heating and expansion steps. The resulting low-pressure CO2 from the discharge operation can be stored in low-pressure storage tanks 146A, which are much cheaper than high-pressure storage tanks. Further, because the discharge operation relies on pipeline CO2 104A, the discharge subsystem 102A is suitable for installation at most, or any, existing CO2 pipeline location and is not otherwise limited to geography or geological features.

Turning to FIG. 3, illustrated therein is a charge subsystem 102B of the system 100. As noted above, the system 100 may initiate a charge operation when there is an excess of power available, in which case, the low-pressure storage tanks 146A are emptied and warm water is generated so there is power generation capacity available if a power deficit occurs (i.e., there is capacity for a further discharge operation). The CO2 storage stream 144A is pumped from the low-pressure storage tanks 146A with a pump 104B to a higher pressure, which may be around 23 bar in some non-limiting examples, to form a first pressurized CO2 stream 106B. In an implementation, the configuration of the pump 104B upstream of the vaporizer is enabled without heat integration between CO2 condensation and vaporization. Such a configuration may utilize a waste chilling stream for condensation in a condensation mode and ambient air vaporize for a vaporizer mode. Other modifications to this arrangement are possible and contemplated herein. The first pressurized CO2 stream 106B is vaporized and superheated, such as to 39 degrees C. in some non-limiting examples, against heating duty at a vaporizer 108B to form a vaporized superheated CO2 stream 110B. The vaporization and superheat duty provides the condensing or cooling duty during the discharge operation. The vaporized superheated CO2 stream 110B is provided to a first compressor 112B where it is compressed to an intermediate-pressure, such as 66 bar in some non-limiting examples to form an intermediate-pressure stream 114B that is cooled to 42 degrees C. with cool water, thereby producing warm water, at a first aftercooler 116B to form a first cooled CO2 stream 118B. The first cooled CO2 stream 118B is compressed to pipeline pressure, such as 150 bar, with a second compressor 120B and cooled to 42 degrees C. again with cool water, thereby producing warm water, with a second aftercooler 122B. An effluent 124B from the second aftercooler 122B is fed to an existing CO2 pipeline. Thus, the effluent 124B may be pipeline CO2 104A described above.

In sum, the charge subsystem 102B is operable to empty the low-pressure storage tanks 146A and generate relatively high-pressure CO2 back to the existing pipeline to provide capacity in the storage tanks 146A for future discharge operations and associated production of power. The cyclical nature of the discharge and charge operations of the system 100 via storage tanks 146A significantly reduces equipment count and plot space relative to other solutions. In addition, the high-pressure CO2 for the power generation or discharge operation is provided by the existing CO2 pipeline (or recycled back to the pipeline) such that high-pressure CO2 storage is not required in the system 100.

FIG. 4 is a schematic illustration of a first thermal integration subsystem 102C-1 of the system 100. In particular, FIG. 4 illustrates heat integration between the preheaters 110A, 118A, 130A and expanders 114A, 122A, 134A of the discharge subsystem 102A and the compressors 112B, 120B and aftercoolers 116B, 122B of the charge subsystem 102B. In other words, FIG. 4 provides additional detail regarding the supply and maintenance of warm water and cool water in the system 100, such as the warm and cool water utilized by, or output by, the preheaters 110A, 118A, 130A of the discharge subsystem 102A and the aftercoolers 116B, 122B of the charge subsystem 102B. The first thermal integration subsystem 102C-1 includes at least one warm water storage tank 104C and at least one cool water storage tank 106C. Warm water from the warm water storage tank 104C is pumped to the preheaters 110A, 118A, 130A of the discharge subsystem 102A during the discharge operation, such as with pump 108C, along conduit 110C. In an implementation, the first thermal integration subsystem 102C-1 includes a first bypass conduit 113C to assist with managing water supply to the preheaters 110A, 118A, 130A and within the subsystem 102C-1 generally. The preheaters 110A, 118A, 130A heat the CO2 stream against warm water provided from the warm water storage tank 104C via pump 108C, thereby producing cool water.

The cool water is conveyed to the cool water tanks 106C. More specifically, cool water from the preheaters 110A, 118A, 130A is provided to a cool water maintenance cooler 112C along conduit 114C and subsequently received at the cool water storage tank 106C following cooling with the maintenance cooler 112C to a preferred temperature for storage in the cool water tank storage 106C. During the charge operation, the cool water from the cool water storage tank 106C is pumped, such as via pump 116C, to the aftercoolers 116B, 122B via conduit 118C. The aftercoolers 116B, 122B cool the CO2 stream against the cool water, thereby producing warm water. The warm water is provided to the warm water storage tank 104C along conduit 120C. In an implementation, the first thermal integration subsystem 102C-1 includes a second bypass conduit 122C to assist with managing water supply to the aftercoolers 116B, 122B and within the subsystem 102C-1 generally. More specifically, the conduit 120C may convey warm water to a maintenance heater 122C to heat the water to a preferred temperature for storage in the warm water storage tank 104C. During a storage or maintenance operation, warm water and cool water may be circulated through the maintenance heater 122C and maintenance cooler 112C, respectively, to maintain the preferred storage temperature in the warm water storage tank 104C and cool water storage tank 106C, respectively. It is also noted that the concepts of the first thermal integration subsystem 102C-1 can be applied equally to other thermal mediums beyond water.

With reference to FIG. 5, the system 100 may further include a second thermal integration subsystem 102C-2 that manages heat integration of the CO2 vaporizer 108B and the condenser 138A. The features and operation of the second thermal integration subsystem 102C-2 may generally be similar to those described above with reference to the first thermal integration subsystem 102C-1 with the second thermal integration subsystem 102C-2 generally operable to manage flow of cool water and warm water, or other appropriate fluid, to and from the vaporizer 108B and condenser 138A. Accordingly, repeat description is omitted. Optimal thermal storage methods and thermal integration techniques are still being investigated and other techniques are contemplated herein. In an implementation, this configuration may be used for a portion of the duty when lower purity CO2 is used rather than for full duty. Such a configuration could be implemented on the cold end of the heat curve at essentially non-flat sections of the heat curve.

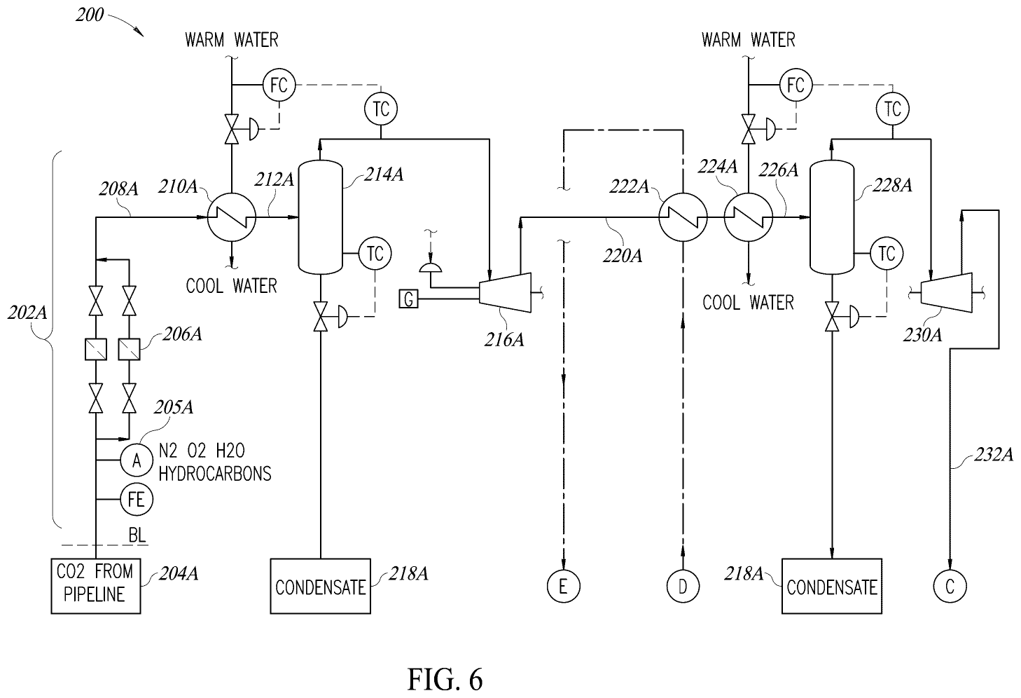

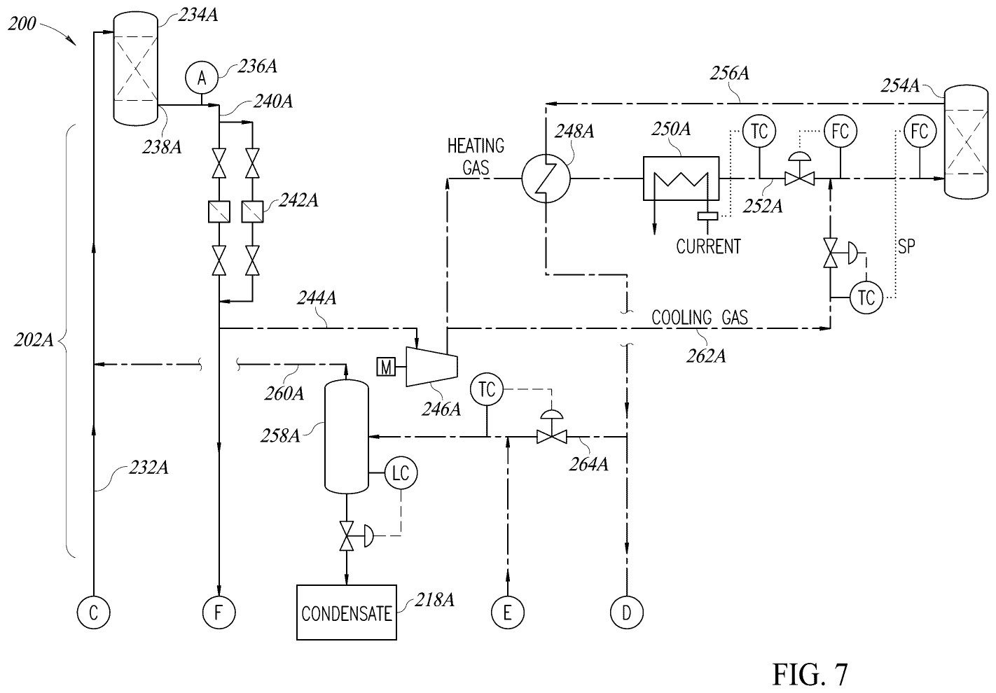

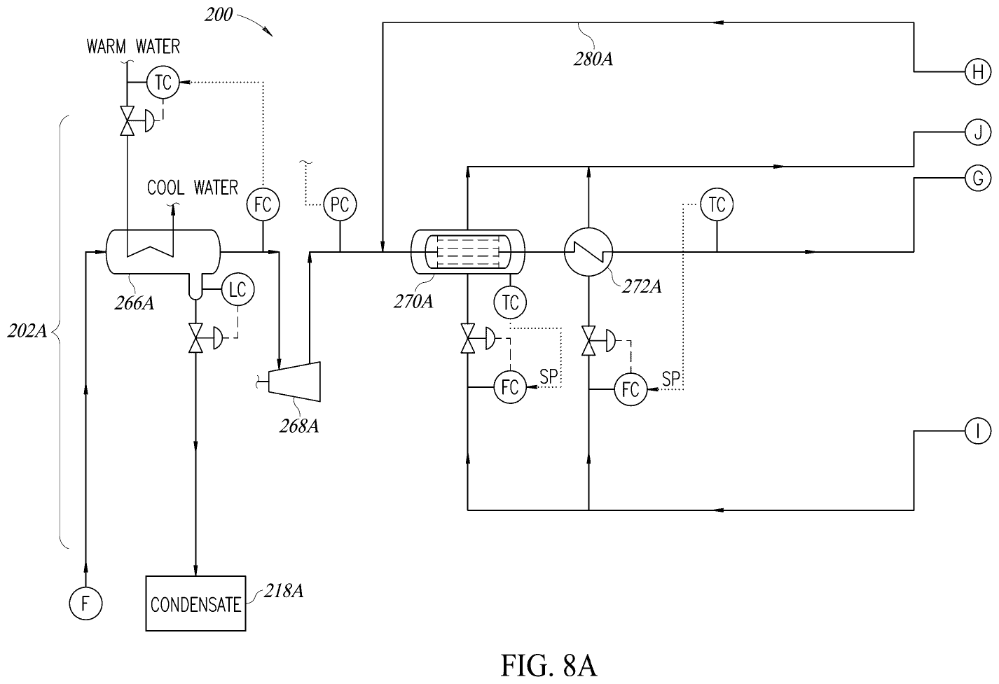

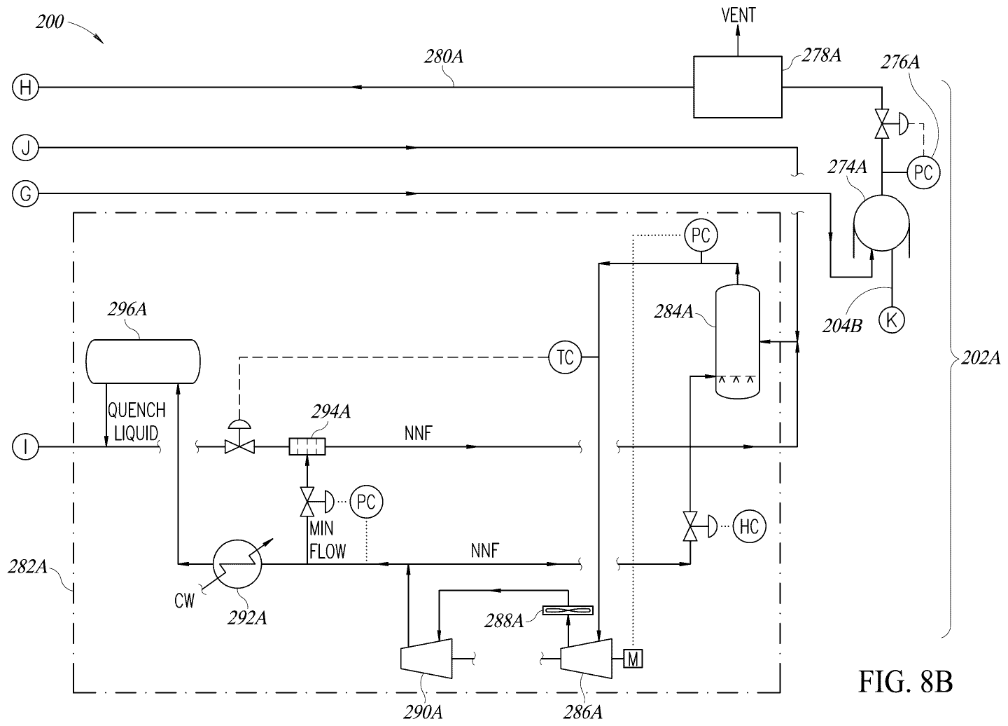

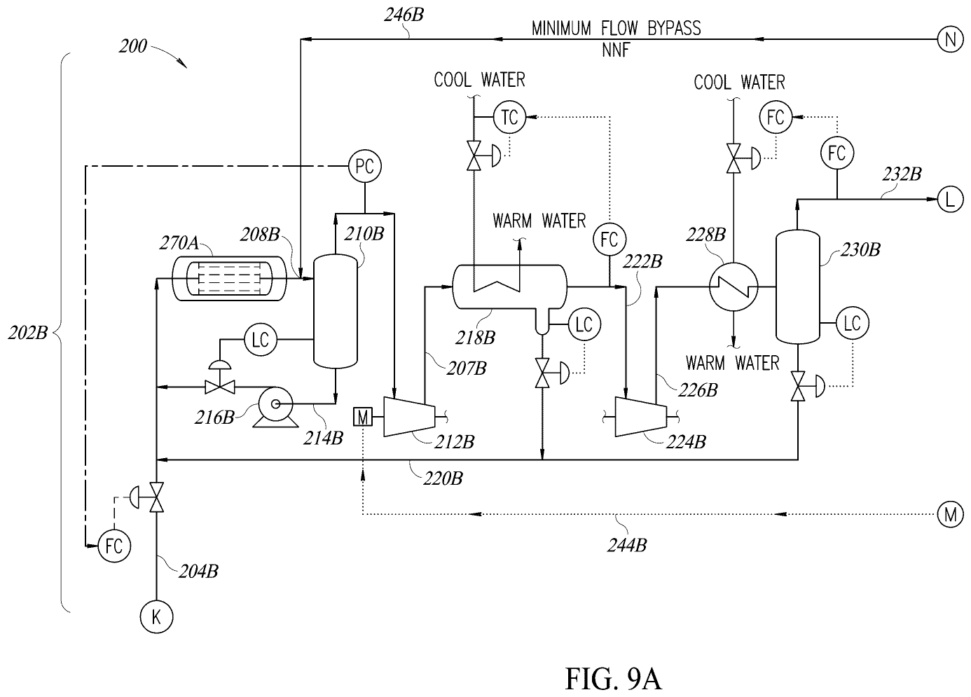

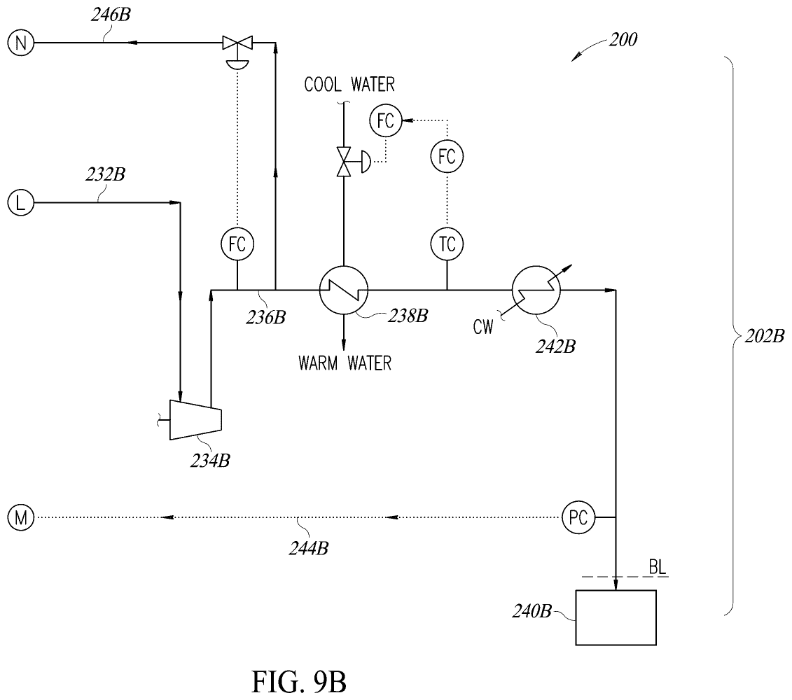

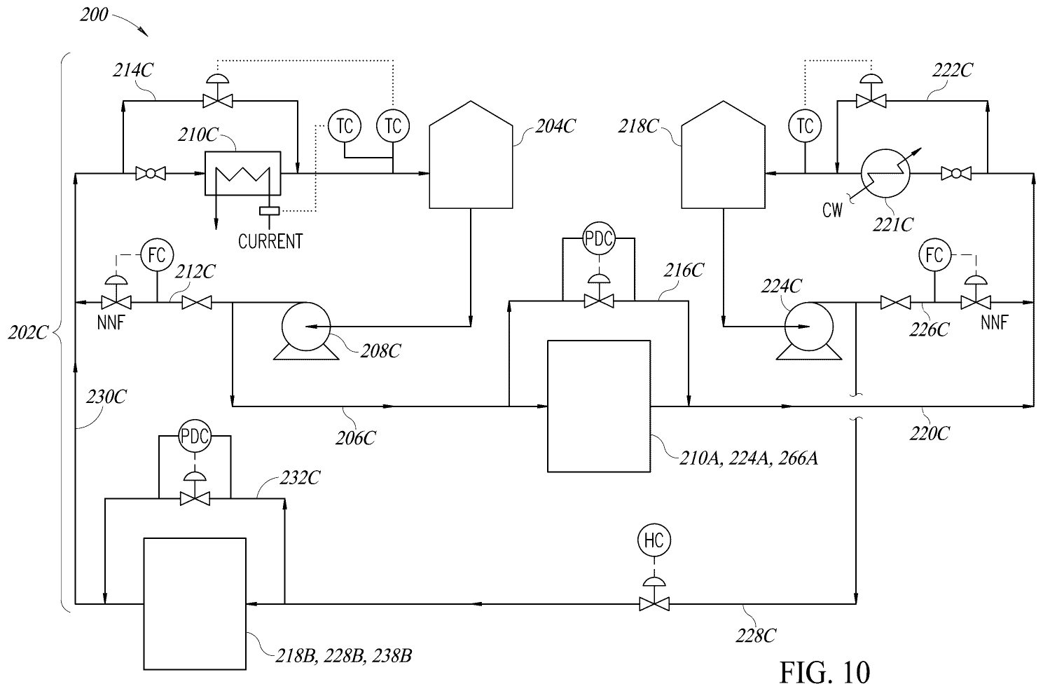

FIG. 6 is a schematic diagram of an implementation of an energy storage system 200, and more particularly, illustrates a first and second expansion stages of a discharge subsystem 202A of the energy storage system 200. FIG. 7 is a schematic diagram illustrating a dryer stage and a dryer regeneration stage of the discharge subsystem 202A. FIG. 8A and FIG. 8B are schematic diagrams illustrating a third expansion stage and low-pressure product condensation stage of the discharge subsystem 202A. FIGS. 9A and 9B are schematic diagrams of a charge subsystem 202B of the system 200, and FIG. 10 is a schematic diagram of a thermal integration subsystem 202C of the system 200. FIGS. 6-10 are provided to illustrate one non-limiting implementation of a system according to the techniques discussed above with reference to FIG. 1. As noted, features of the system 200 in FIGS. 6-10 may be optimized based on various factors. Unless the context clearly dictates otherwise, the arrows in the schematic flow lines of FIGS. 6-10 represent direction of fluid flow.

Beginning with FIG. 6, when there is a deficit of power generation from renewable energy sources, the energy storage system 200 will operate in discharge mode and activate aspects of the discharge subsystem 202A. Incoming pipeline CO2 204A at relatively high-pressure is first filtered with a filter 206A to remove pipeline rouge and produce a filtered CO2 stream 208A. In an implementation, the filter 206A may include more than one filter 206A to increase capacity and/or for maintenance purposes, such as to provide one or more spare filters. Further, a composition analyzer 205A may be provided between the inlet of the pipeline CO2 204A and the filter 206A to determine the presence of nitrogen (N2), oxygen (O2), water (H2O), and hydrocarbons in the pipeline CO2. The determined composition may then be utilized to activate various optional aspects of the system 200. The filtered, high-pressure CO2 stream 208A is heated with a high-pressure interstage heater/cooler 210A against warm water, thereby producing cool water, to form a first heated CO2 stream 212A with the high-pressure. In an implementation, the first heated CO2 stream 212A is conveyed to a high-pressure knockout drum 214A before being sent to a first stage turbo-expander 216A to generate power, as described herein. The high-pressure knockout drum 214A may output condensate 218A. During normal and routine operations, there may be no flow of condensate 218A. The high-pressure knockout drum 214A is provided to ensure no liquid carry-over to the expander 216A because liquid carry-over may cause mechanical damage. Condensate 218A may occur during an upset scenario, but is not a normal operation in preferred implementations. The same applies to other knock-out drums and expanders described herein, unless the context dictates otherwise. The first stage turbo-expander 216A lowers a pressure of the first heated CO2 Stream 212A following the knock-out drum 214A to form a first intermediate-pressure CO2 stream 220A that may be provided to a dryer regenerator gas cooler 222A described elsewhere before being heated in a medium-pressure interstage heater/cooler 224A against warm water, thereby producing cool water, to form a second heated CO2 stream 226A.

In an implementation, the second heated CO2 stream 226A is provided to a medium-pressure knockout drum 228A, which removes condensate 218A from the second heated CO2 stream 226A. An effluent from the medium-pressure knockout drum 228A is sent to a second stage turbo-expander 230A to generate power. At the second stage turbo-expander 230A, the pressure of the effluent from the medium-pressure knockout drum 228A is further reduced to provide work to generate power, as described herein, and produce a second intermediate-pressure CO2 stream 232A with a lower pressure than the first intermediate-pressure CO2 stream 220A. The second intermediate CO2 stream 232A is dried in a molecular sieve drying system or a dryer stage described further with reference to FIG. 7.

Turning to FIG. 7, illustrated therein is a dryer stage and dryer regeneration facilities of the discharge subsystem 202A. The second intermediate-pressure CO2 stream 232A from the second turbo-expander 230A is provided to a CO2 dryer 234A, which may be a molecular sieve drying system that is referred to herein as an “online dryer 234A.” The number of dryers 234A and cycle time are dependent on capacity or throughput of the system 200. It is initially anticipated that the discharge subsystem 202A will include at least one spare dryer 254A (i.e., minimum two dryers 234A, 254A total) and dryer regeneration will take place a minimum of once every 24 hours in some implementations. The dryer 254A may be referred to as an “offline dryer 254A” in this example and is described further below. Alternatively, the disclosure contemplates more than one dryer 234A. A moisture analyzer 236A at an outlet 238A of the dryer 234A indicates when the dryer 234A is spent and would benefit from regeneration. The dryer 234A is operable to dry the second immediate pressure CO2 stream 232A and produce a dried CO2 stream 240A. A filter 242A is provided at the outlet of the dryer 234A, and in some examples, downstream of the moisture analyzer 236A, to remove desiccant fines from the dried CO2 stream 240A that is output from the dryer 234A.

With reference back to FIG. 7 and continuing reference to FIG. 6, the discharge subsystem 202A further includes dryer regeneration facilities. A portion of the dried CO2 stream 240A (i.e., effluent from CO2 dryer 234A) is used for regeneration and may be referred to herein as a slip stream 244A. The slip stream 244A is preferably a minor portion of the dried CO2 stream 240A in some implementations, meaning that the slip stream 244A is anything less than 50% of the total flow, although the same is not necessarily required and the slip stream 244A may be a majority of the dried CO2 stream. The slip stream 244A is first compressed in a dryer regeneration gas blower 246A. After the blower 246A, the slip stream 244A is heated in a dryer regeneration heating step. Specifically, the discharge or effluent from the blower 246A is preheated in an effluent exchanger 248A (which may also be referred to herein as a dryer regeneration gas feed exchanger 248A) before being heated to a final regeneration temperature in a dryer regeneration gas electric heater 250A to form a heated regeneration gas stream 252A. The heated regeneration gas stream 252A is provided to a further dryer 254A, which may be a desiccant bed, and the resulting effluent 256A is cooled at a first instance at the effluent exchanger 248A against the heating gas provided from the blower 246A (i.e., heating gas from slip stream 244A).

The initially cooled regeneration stream is further cooled at a second instance by the dryer regenerator gas cooler 222A shown in FIG. 6. The dryer regenerator gas cooler 222A provides cooling from the discharge from the first stage turbo-expander 216A of FIG. 6. In turn, the heating duty in the medium-pressure interstage heater/cooler 224A will be reduced during this mode of operation. The cooled regeneration gas effluent from the dryer regenerator gas cooler 222A is sent to a dryer generation gas knockout drum 258A to remove free water desorbed during regeneration and the resulting effluent 260A is then sent to an inlet of the dryer 234A. During a dryer regeneration cooling step, the discharge from the blower 246A is not provided to the effluent exchanger 248A, but rather, is sent directly to the offline dryer 254A along conduit 262A. No heat duty is supplied in the effluent exchanger 248A, and the effluent 256A from the offline dryer 254A and offline exchanger 248A can be sent directly to the knock-out drum along conduit 264A on temperature control.

Turning to FIG. 8A and FIG. 8B with continuing reference to FIG. 6 and FIG. 7, the dried CO2 stream 240A from the dryer 234A is sent to a low-pressure interstage heater/cooler 266A where the dried stream 240A is heated against warm water, thereby producing cool water. The heated, dried CO2 stream 240A is then provided to a third stage turbo-expander 268A to generate power at a third instance. In an implementation, the final stage pressure (i.e., pressure at the third stage turbo-expander 268A) is controlled by an inlet guide vane actuator of the third stage turbo-expander 268A. The discharge or effluent from the third stage turbo-expander 268A is provided to a CO2 condenser/vaporizer thermal store 270A (which may be referred to herein as a thermal store 270A). The thermal store 270A uses a phase change material and/or thermal storage materials to store the heat of condensation and vaporization between charge and discharge operations described herein. The thermal storage material may be a phase change material alone or could be a combination of phase change material and a sensible heat storage material (such as rocks, sand, liquid hydrocarbon, etc. in some non-limiting examples). A phase change material is preferred for the latent heat part of the heat curve (i.e., the flat part of the curve benefits from a phase change material to mirror the shape of the heat curve). For the sensible heat portion of the heat curve (i.e., superheating/desuperheating the CO₂), a storage material like rocks, sand, hydrocarbon liquid (i.e., butane, pentane) etc. may be optimal. During the discharge operation described with reference to FIGS. 5-7B, the thermal storage material will be heated or melted, depending on storage method and material, by the process stream, such as discharge from the third stage turbo-expander 286A, and supply cooling to the process stream or discharge. The effluent from the thermal store 270A is then sent to a CO2 product chiller 272A, which uses refrigerant to chill the low-pressure CO2 product from before it is sent to storage in one or more CO2 storage tanks 274A or other storage media 274A shown in FIG. 8B. In an implementation, the CO2 product chiller 272A is optional, in which case, the thermal store 270A is capable of cooling the low-pressure CO2 product to a preferred storage temperature and the cooled low-pressure CO2 product may be provided directly to the one or more CO2 storage tanks 274A. Further, in some implementations the CO2 is stored in the storage media in a condensed state (i.e., the CO2 is re-condensed before storage). In some types of storage media, such as underground caverns, it may instead be preferred to store the low pressure CO2 as a vapor. Thus, the phase of the low pressure storage may be selected based on various factors.

In an implementation, noncondensables are vented from the storage tank 274A on pressure control 276A and sent to a CO2 vent membrane system 278A where CO2 is separated from the noncondensable components, which may be primarily nitrogen and oxygen. The recovered CO2 stream 280A is returned to the thermal store 270A for condensation and noncondensables are vented. The composition of noncondensables is an important factor to consider in the design of the venting location or destination. Common noncondensables are nitrogen and oxygen, but if hydrocarbons or other greenhouse gas contributors are present, the vent stream destination should be reevaluated and may be located elsewhere in the system to reduce greenhouse gas emissions. In an implementation, the CO2 vent membrane system 278A is optional and may be utilized for systems, such as system 200, with access to pipelines containing low CO2 and high nitrogen content in the pipeline (i.e., where pipeline CO2 204A contains relatively low CO2 and high nitrogen content).

The discharge subsystem 204A may optionally include a refrigerant package 282A. The features of the refrigerant package 282A are indicated with a dashed box in FIG. 8B. The refrigerant package 282A combines propylene and ethylene as a single stream of constant composition consisting of 70 mol % propylene and 30 mol % ethylene in some implementations, although other mol % compositions of propylene and ethylene are considered, as well as other refrigerants. The refrigerant package 282A may be a closed loop, two stage system, as described further below.

In implementations that include the refrigerant package 282A, the refrigerant effluent from the product chiller or subcooler 272A is provided to a first stage suction drum 284A to remove entrained liquid. The suction drum 284A may operate dry and may be equipped with a sparger to help remove any liquid that may accumulate. The discharge from the first stage suction drum 284A is provided to a first refrigerant compressor 286A, followed by a first stage intercooler 288A, and a second refrigerant compressor 290A. During routine and normal operation, the discharge from the second refrigerant compressor 290A is provided to a condenser 292A and then an accumulator 296A. Liquid from the accumulator 296A is letdown in pressure to provide refrigeration to the CO2 product chiller 272A. In a sparger operation that is not part of normal, routine operation, discharge from the second refrigerant compressor 290A may be split with a first portion provided back to the first stage suction drum 284A to remove any liquid that may accumulate. In a minimum flow operation that is not part of normal, routine operation, discharge from the second refrigerant compressor 290A may be split with a second portion provided as a recycle portion for minimum flow operation of the compressor 290A via mixer 294A. During minimum flow operation, the liquid from the accumulator 296A may be split with a portion provided to a mixer 294A with output from the mixer 294A provided back to the first stage suction drum 284A. The superheated min flow vapor and quench liquid is mixed at the mixer 294A to provide a vapor stream that is slightly superheated (i.e., approximately 10° C. superheat in non-limiting examples). The mixer 294A may only be utilized for mixed refrigerant systems and only operated during minimum flow operations when the system 200 is operating at low loads to prevent the compressor 290A from going into surge. The cooled condenser portion output from the condenser 292A is provided to an accumulator 296A, which provides liquid holdup of the system. Liquid from the accumulator 296A is letdown in pressure to provide refrigeration to the CO2 product chiller 272A. The superheated refrigerant from the chiller 272A is then directed to back to the first stage suction drum 284A. In some implementations, the refrigerant effluent is directed to the thermal store 270A during prolonged storage times to the maintain the charge condition in a similar concept to the techniques of the thermal management subsystems 102C, 202C described herein.

The CO2 vent membrane 278A is preferably implemented when the CO2 pipeline purity (i.e., purity of pipeline CO2 204A) is sufficiently low and has a sufficiently high content of noncondensables, resulting in the bubble point temperature of the stream being too far below the CO2 saturation temperature. These conditions will make it impractical to achieve condensation with the thermal store 270A alone. The cold end of the exchanger 270A may not be suitable for storage via phase change material due to the steep slope of the heat curve. It is less preferred to use sensible heat thermal storage in such implementations due to the large duty associated with fully condensing the noncondensable components. These conditions will also make it impractical to achieve condensation with a thermal store 270A and chiller 272A combined. The preferred refrigeration temperature is significantly lower, thereby negatively impacting the net power produced, materials of construction, refrigerant composition and/or configuration, and capital expenditure of the overall system 200.

In an implementation, the system 200, and more specifically the discharge subsystem 202A with the CO2 vent membrane 278A (but optionally without the refrigerant system 284A) is designed to achieve >99.55% CO₂ recovery, which accounts for an approximate 90% recovery via CO2 vent membrane system 278A. The refrigerant system 284A may be optional and could be selected for inclusion to improve the reliability of the overall system by placing less emphasis on the thermal store 270A for providing cold duty and instead providing a reliable source of cold duty via the refrigerant system 284A.

In an implementation, the CO2 product chiller 272A and refrigerant system 282A are optional and not required for the system 200, but may be desirable for operating flexibility and reliability. Removing these aspects shifts the chilling duty to the thermal store 270A, which may increase the net power generation by eliminating the refrigerant compressors 286A, 290A, decrease the size of equipment, and reduce the cost of the system 200. The first stage suction pressure during charge operation, as described below, will preferably decrease to maintain acceptable temperature approach in the thermal store 270A. The specific power of the CO2 compressor will increase, but the net impact when considering removal of the refrigerant compressors 286A, 290A is an improvement in efficiency.

FIG. 9A and FIG. 9B are schematic diagrams illustrating the charge subsystem 202B of the energy storage system 200. With continuing reference to FIGS. 7A and 7B, when excess power is available from renewable sources, liquid CO2 204B from the storage tank 274A is letdown in pressure and superheated in the CO2 condenser/vaporizer thermal store 270A. The same thermal store 270A is utilized to enable heat integration between the subsystems described herein. The letdown pressure is such that sufficient temperature approach is maintained between charge operation, the thermal store material, and discharge operation. During the charge operation described with reference to FIG. 9A and FIG. 9B, the thermal storage material will be cooled or frozen, depending on storage method, by the process stream, such as liquid CO2 204B, and supply heating to the process stream or liquid CO2 204B to vaporize the process stream and form a vaporized CO2 stream 208B. The vaporized CO2 stream 208B is then sent to a CO2 compressor first stage suction drum 210B where any liquid is separated before feeding a first stage compressor 212B. Should any liquid be present, it is pumped back to an inlet of the thermal store 270A along conduit 214B via pump 216B. Among other aspects, the first stage compressor 212B increases a pressure of the vaporized CO2 stream 208B to form a low-pressure CO2 stream 207B.

The low-pressure CO2 stream 207B is provided from the first stage compressor 212B to a low-pressure interstage heater/cooler 218B where the stream 207B is cooled by cool water from the thermal integration system described with reference to FIG. 10, thereby producing warm water. Any liquid in the stream 207B from the cooling operation at the low-pressure interstage heater/cooler 218B is provided back to the inlet of the thermal store 270A along conduit 220B. The conduit 220B may only be provided for upset conditions in some implementations and is not utilized during normal operating conditions. The same applies to other liquid recycle conduits described for other stages. An initially cooled effluent 222B from the low-pressure interstage heater/cooler 218B is provided to a second stage CO2 compressor 224B, which further increases the pressure to form a medium-pressure stream 226B. The medium-pressure stream 226B is provided to a medium-pressure interstage heater/cooler 228B where the medium-pressure stream 226B is again cooled by cool water from the thermal integration system, thereby producing warm water. The warm, medium-pressure effluent from the medium-pressure interstage heater/cooler 228B is provided to a medium-pressure knockout drum 230B for removal of condensate that is provided back to the thermal store 270A along conduit 220B. An effluent 232B from the medium-pressure knockout drum 230B is further compressed, thereby increasing pressure, with a third stage compressor 234B to produce a high-pressure CO2 stream 236B that is further cooled by a high-pressure interstage heater/cooler 238B against cool water from the thermal integration system, thereby producing warm water.

In an implementation, the high-pressure interstage heater/cooler 238B cools the high-pressure CO2 stream 236B to a final temperature for return to a CO2 pipeline 240B (i.e., pipeline CO2 204A). In some aspects, a CO2 product trim cooler 242B is provided downstream of the high-pressure interstage heater/cooler 238B to further cool the cooled, high-pressure CO2 stream 236B to final temperature for return to the CO2 pipeline 240B. The first stage compressor 212B may be adjustable, such as at least with respect to motor speed, to maintain final stage discharge pressure. Adjustment of the first stage compressor 212B is controlled by electrical control signals provided along dashed line 244B in FIG. 9B. In other words, dashed line 244B represents compressor control logic for the first stage compressor 212B.

In some implementations, there is a need to protect the compressor 212B or compressors 212B, 218B, 224B, from damage during low throughput, in which case, all, or at least a portion of, the high-pressure CO2 stream 236B may be recirculated or recycled to the first stage suction drum 210B for further processing along conduit 246B. The conduit 246B may be a minimum flow bypass that redirects the high-pressure CO2 stream 236B to the first stage suction drum 210B prior to final cooling by the high-pressure interstage heater/cooler 238B and/or trim cooler 242B. Thus, in sum, the charge subsystem 202B may include a three-stage compressor with interstage cooling. The trim cooler 242B may be provided before returning the CO2 product to the pipeline 240B. The cool water and warm water described above with respect to the discharge subsystem 202A and/or charge subsystem 202B is provided by a thermal integration subsystem 202C described further with reference to FIG. 10.

FIG. 10 is a schematic diagram illustrating the thermal integration subsystem 202C of the energy storage system 200. In general, the thermal integration subsystem 202C is in fluid communication with the high-pressure, medium-pressure, and low-pressure interstage heater/coolers 210A, 224A, 266A of the discharge subsystem 202A (which may be collectively referred to as heaters 210A, 224A, 266A) shown in FIG. 6 and FIG. 8A as well as the low-pressure, medium-pressure, and high-pressure interstage heater/coolers 218B, 228B, 238B (which may be collectively referred to as coolers 218B, 228B, 238B) of the charge subsystem 202B shown in FIG. 9A and FIG. 9B. In an implementation, the heater/coolers 210A, 224A, 266A and 218B, 228B, 238B are the same equipment (i.e., heater/cooler 210A is the same as heater/cooler 218B, etc.) and may be heat exchangers. During the charge operation, the heat exchangers operate as a compressor aftercooler and during discharge operation, the same exchanger operators as an expander preheater. The same is not necessarily required, but is preferable as a cost saving measure. Heating duty for heaters 210A, 224A, 266A is supplied by a warm water storage tank 204C along conduit 206C via pump 208C. In an implementation, the warm water storage tank 204C and pump 208C are optionally in communication with a trim heater 210C in a fluid loop along conduit 212C with the trim heater 210C operable to maintain the warm water temperature in the warm water storage tank 204C during prolonged storage times. In other words, water may be circulated by the warm water storage tank 204C in a warm water maintenance circuit through trim heater 210C to maintain storage temperature over time. The trim heater 210C is optional and may be omitted where prolonged storage times are not contemplated in the system 200. A first bypass 214C may be associated with the trim heater 210C such that circulating warm water can bypass the trim heater 210C where further heating is not desired.

The thermal integration subsystem 202C may further include a second bypass 216C associated with the heaters 210A, 224A, 266A that may be selectively utilized based on flow rate and operational status of the heaters 210A, 224A, 266A, among other factors. During the discharge operation via discharge subsystem 202A, warm water is pumped to the heaters 210A, 224A, 266A, generating cool water that is collected in a cool water storage tank 218C along conduit 220C. In an implementation, the cool water generated by the heaters 210A, 224A, 266A is first provided to a trim cooler 221C upstream of the cool water storage tank 218C that is operable to cool the incoming water, as needed, to a preferred storage temperature for storage in cool water storage tank 218C. In implementations where further cooling of the incoming water is not desirable, a third bypass 222C is associated with the trim cooler 221C and may direct incoming cool water around the trim cooler 221C to avoid further cooling.

Similar to warm water storage tank 204C, the cool water storage tank 218C may optionally be in communication with a pump 224C in a fluid loop with the trim cooler 221C along conduit 226C for recirculation of cool water from the cool water storage tank 218C and maintenance of preferred cool water storage temperature in a cool water maintenance circuit over prolong storage periods. The conduit 226C and associated cool water maintenance circuit may be optional in implementations where prolonged storage is not contemplated. During a charge operation with charge subsystem 202B, cooling duty is supplied to the coolers 218B, 228B, 238B from the cool water storage tank 218C via pump 224C along conduit 228C. The warm water generated by the coolers 218B, 228B, 238B is provided back to the warm water storage tank 204C along conduit 230C with the trim heater 210C optionally utilized to heat the circulating water to a preferred temperature for storage in warm water storage tank 204C. A fourth bypass 232C may be associated with the coolers 218B, 228B, 238B to assist with controlling fluid flow through the coolers 218B, 228B, 238B. Other aspects of the system 200 that rely on warm water or cool water for heating or cooling duty, respectively may also be in communication with the thermal integration subsystem 202C, even if not expressly discussed above.

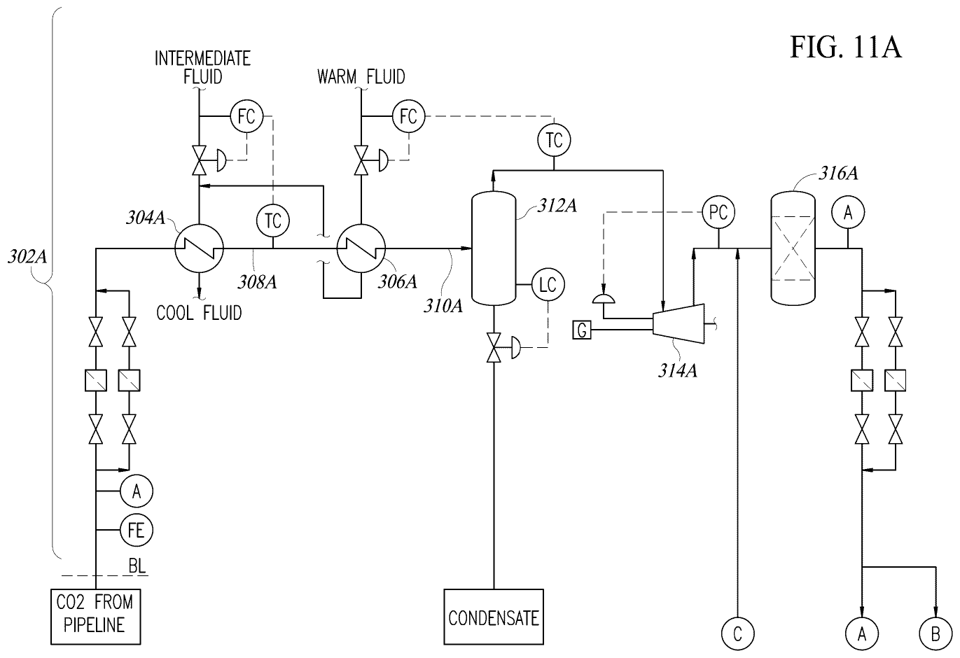

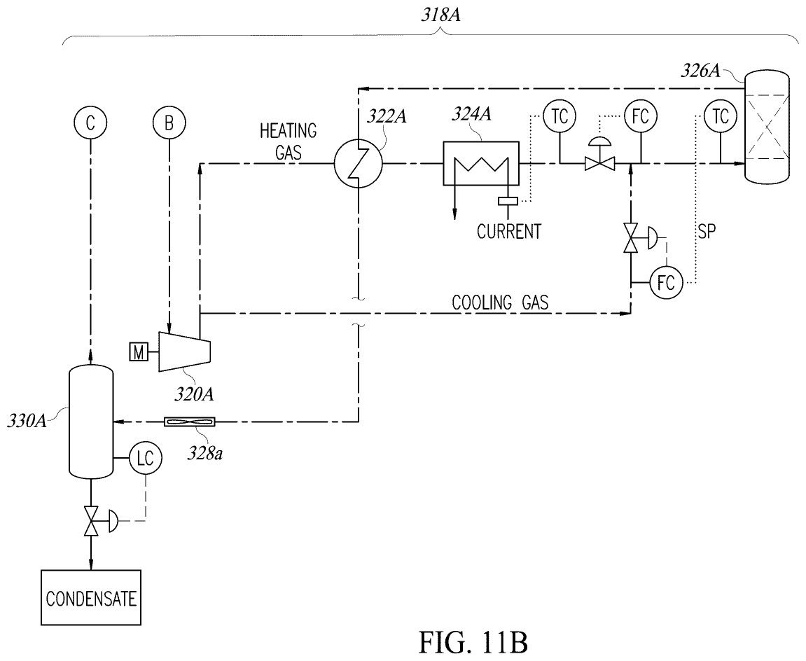

FIGS. 11A-13 are schematic views of an implementation of an energy storage system 300. System 300 may be similar to the other systems 100, 200 described herein, except as otherwise indicated below, and thus repetitive description is omitted. In particular, FIGS. 11A-13 are provided to explain a low-capital expenditure system relative to some other implementations, meaning a simplified system with lower initial investment costs while still achieving the benefits and advantages described herein.

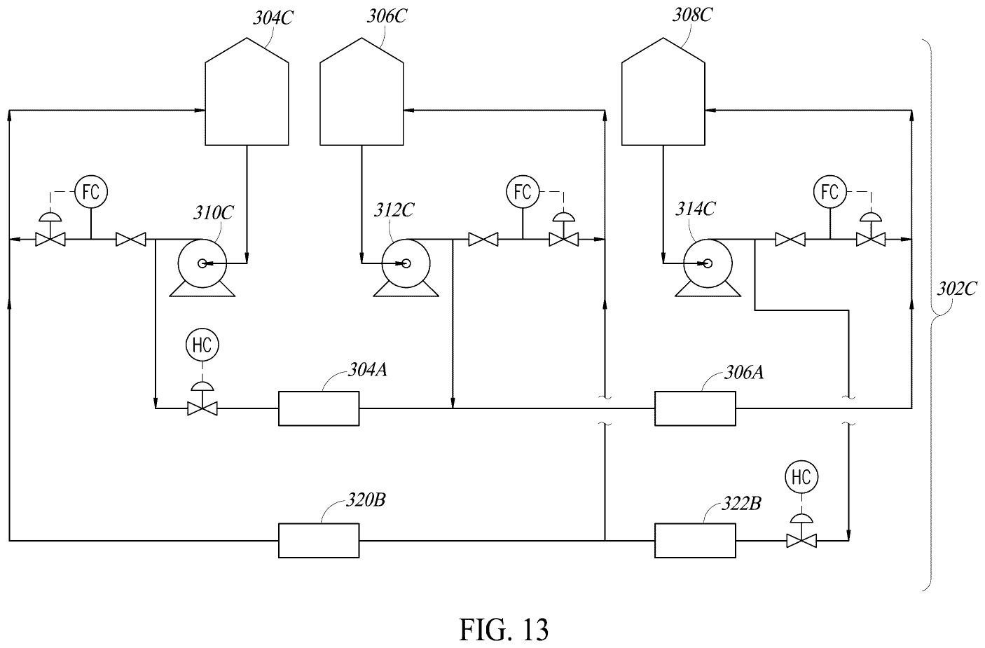

Beginning with FIG. 11A, illustrated therein is a discharge subsystem 302A of the system 300. The discharge subsystem 302A may include incoming pipeline CO2 that is heated in a two-stage process to a relatively higher temperature than in the system 200 before further processing. Specifically, the pipeline CO2 is provided to a first stage heater and/or cooler 304A followed by a second stage heater and/or cooler 306A. Each of the first and second stage heater and/or coolers 304A, 306B are in fluid communication with a thermal management subsystem 302C (which may also be referred to as a thermal integration subsystem 302C) described with reference to FIG. 13 and may use a heat transfer fluid, which may be any of the fluids described herein, or others, to transfer heat to the incoming pipeline CO2. The pipeline CO2 is first heated at the first stage heater and/or cooler 304A against intermediate temperature fluid to form an intermediate CO2 stream 308A. The intermediate fluid is provided, at least in part, from the thermal management subsystem 302C and the heating against the intermediate fluid produces cool fluid that is returned to the thermal management subsystem 302C. Then, the intermediate stream 308A is heated at the second stage heater and/or cooler 306A against warm fluid to form a heated CO2 stream 310A that is provided to a knockout drum 312A. The heating against the warm fluid produces intermediate temperature fluid that is combined with the intermediate fluid from the thermal management subsystem 302C to provide the intermediate fluid for the first stage. The output from the knockout drum 312A is provided to a turbo-expander 314A to generate power, as described herein. In an implementation, the discharge subsystem 302A includes only a single turbo-expander 314A, which is a further difference to the other systems described herein.

In an implementation, the heat exchange process adds heat to raise a temperature of the pipeline CO2 in two stages associated with the two heaters and/or coolers 304A, 306A instead of in a single stage as in other implementations. The number of heating and cooling stages is non-limiting and may be one, two, three, four or more stages in the discharge subsystem 302A. The output from the turbo-expander 314A is provided to a dryer 316A. In the discharge subsystem 302A, there may not be a dryer regenerator gas cooler or a further interstage heater/cooler between the turboexpander 314A and the dryer 316A, which helps to reduce equipment count and capital costs.

The dryer 316A may be in fluid communication with a dryer regeneration subsystem 318A best shown in FIG. 11B. The dryer regeneration subsystem 318A may be part of the discharge subsystem 302A, or may be an independent and separate subsystem. The dryer regeneration subsystem 318A may include a regeneration gas blower 320A in fluid communication with a regeneration gas feed/effluent exchanger 322A, a regeneration gas heater 324A, a further CO2 dryer 326A, a regeneration gas air cooler 328A, and a regeneration gas knockout drum 330A. Each of these components are similar to other implementations described elsewhere, but it is noted that the dryer 316A operates at a relatively lower pressure than in other systems described herein and therefore has a lower design pressure and a thinner vessel or lower vessel thickness. Such an arrangement decreases capital cost.

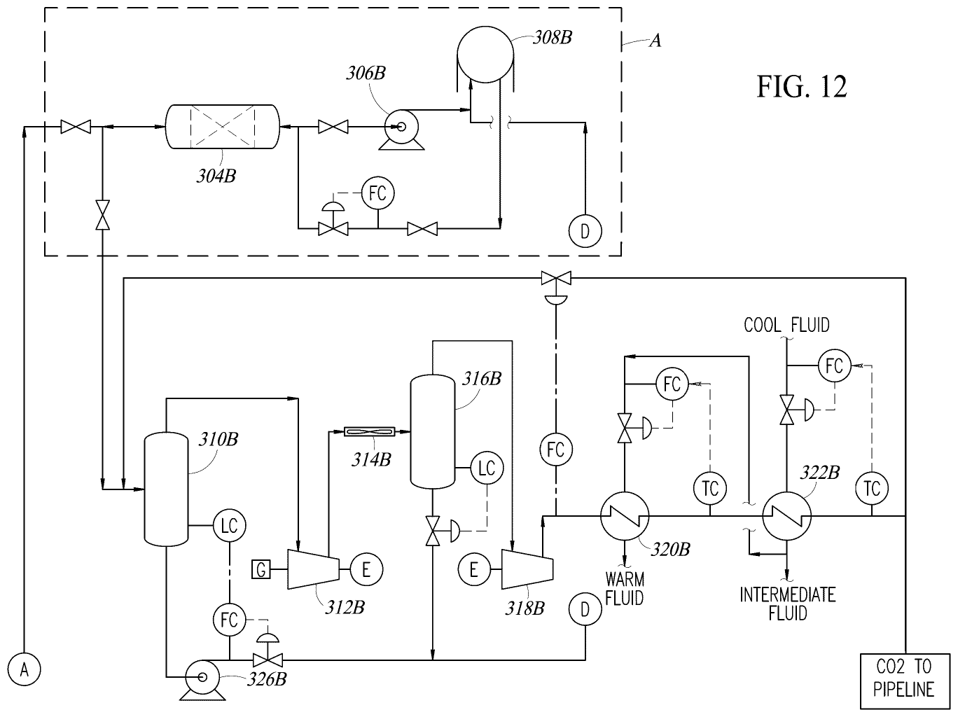

FIG. 12 is a schematic diagram of a charge subsystem 302B of the system 300 that is in fluid communication with the discharge subsystem 302A. After the CO2 is heated and expanded to generate power, as described elsewhere, the CO2 is optionally stored at low pressure to reduce storage costs and then cooled and pressurized with the charge subsystem 302B before it is returned to the existing pipeline. The charge subsystem 302B includes a CO2 condenser/vaporizer thermal store 304B in communication with the incoming low pressure, relatively high temperature CO2 stream from the discharge subsystem 302A along line A-A. The condenser/vaporizer thermal store 304B may be in fluid communication with a CO2 pump 306B and a low-pressure CO2 storage tank 308B in a fluid loop. In between charge and discharge operations, the CO2 may be stored in the tank 308B. During a discharge operation, the thermal store 304B cools and/or condenses the incoming low pressure, relatively high temperature CO2 stream prior to storage in the tank 308B. When the charge operation is initiated, the CO2 is provided from the tank 308B through the condenser/vaporizer thermal store 304B to heat and/or vaporize the low pressure, cooled CO2 stream from the storage tank 308B and the heated and/or vaporized stream is provided to a first stage suction drum 310B and subsequently to a first stage compressor 312B. After the first stage compressor 312B, the output is provided to a first stage aftercooler 314B followed by a second stage drum 316B and a second stage compressor 318B. The compressed CO2 stream from the second stage compressor 318B is provided to a warm-side heater/cooler 320B followed by a cool-side heater/cooler 322B. The heater/coolers 320B, 322B cool the compressed CO2 stream in two stages. First, at the warm-side heater/cooler 320B, the compressed CO2 stream is cooled against intermediate fluid, thereby producing warm fluid that is provided to the thermal management subsystem 302C. At the cool-side heater/cooler 322B, the intermediate temperature compressed CO2 stream is further cooled against cool fluid from the thermal management subsystem 302C, thereby producing intermediate fluid that is used for the warm-side cooling stage. Additionally or alternatively, the intermediate fluid produced by the cool-side cooling stage can be provided back or returned, in full or in part, to the thermal management subsystem 302C. The output cooled, compressed CO2 stream from the cool-side heater/cooler 322B is provided back to the existing pipeline as described further elsewhere.

In addition, the charge subsystem 302B may include a CO2 pump 326B in fluid communication with the first and second stage knockout drums 310B, 316B and the low-pressure storage tank 308B in order to return liquid carryover to the storage tank 308B for further processing in the event of a system upset. Under normal operating conditions, there is typically no fluid flow through the pump 326B back to the storage tank 308B. As such, the charge subsystem 302B may provide for pressurizing and cooling the CO2 to suitable conditions for return to the pipeline using only two knock-out and compression stages and only two heat transfer/cooling stages, which reduces equipment count and capital costs.

FIG. 13 provides more detail of the thermal management subsystem 302C. The thermal management subsystem 302C is in fluid communication with the discharge and charge subsystems 302A, 302B as described above for providing fluids of different temperatures for use in those subsystems 302A, 302B. The thermal management subsystem 302C includes a warm fluid storage tank 304C, an intermediate fluid storage tank 306C, and a cool fluid storage tank 308C. Each of the thanks 304C, 306C, 308C are in fluid communication with a respective circulation pump 310C, 312C, and 314C to circulate fluid in independent fluid loops to maintain temperature over time. Each of the tanks 304C, 306C, 308C are also in fluid communication with the first stage heater and/or cooler 304A and second stage heater and/or cooler 306A of the discharge subsystem 302A and the warm-side heater/cooler 320B and cool-side heater/cooler 322B of the charge subsystem 302B. Further, as noted above, the thermal management subsystem 302C may be implemented using any one of a variety of different working fluids or heat transfer fluids, including any of those described herein and others.

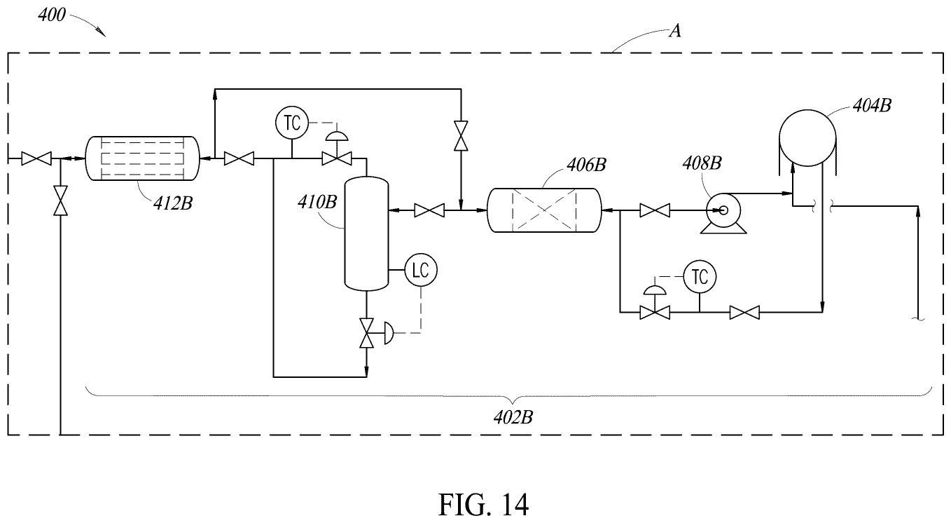

FIG. 14 is a schematic view of an implementation of a system 400 that is adapted for higher efficiency and/or energy density than other systems described herein. System 400 may be similar to systems 100, 200, and 300, except as otherwise provided below, and repeat description is omitted. In particular, in the system 400, a discharge subsystem, dryer regeneration subsystem, and thermal management subsystem may be substantially similar to the corresponding subsystems 302A, 318A, and 302C of the system 300. Thus, the differences between the system 400 and the system 300 are with respect to the charge subsystem.

Specifically, FIG. 14 is a schematic view of an alternative implementation of part of a charge subsystem 402B that corresponds to the part of the charge subsystem 304B in area A in FIG. 12. In other words, the part of the charge subsystem shown in FIG. 14 may be substituted for the part of the charge subsystem in area A in FIG. 12 to increase efficiency in the system 400. Other aspects of the charge subsystems 302B, 402B as well as the systems 300, 400 generally may be substantially the same and thus are not illustrated.

In the charge subsystem 402B, and during a charge operation, low pressure CO2 from a low-pressure storage tank 404B is optionally provided to a CO2 trim condenser/vaporizer thermal store 406B. The output from the thermal store 406B is provided to a thermal store separator 410B and subsequently to a further CO2 condenser/vaporizer thermal store 412B before being provided to the remainder of the charge subsystem 402B. Each of the thermal stores 406B, 412B may operate similarly to the thermal store 304B described above to heat and/or vaporize the CO2 stream from the tank 404B during the charge operation. During a discharge operation, incoming low pressure and relatively high temperature CO2 from the discharge subsystem is provided to the thermal stores 406B, 412B in two stages, with the thermal stores having a similar function to cool and/or condense the incoming CO2 before storage in the tank 404B as described with reference to thermal store 304B. Thus, there are two stages of thermal stores 406B, 412B in the discharge subsystem 402B, which helps increase efficiency.

This configuration is particularly beneficial in applications where the cost of charging the system 400 is high. If the cost of electricity during the charge operation is high, it is beneficial to have a higher efficiency despite some additional capital expenditure and/or increase in equipment count. The higher efficiency is achieved by increasing the suction pressure of the first stage compressor (i.e., compressor 312B in FIG. 12). Without the additional equipment shown in FIG. 14, the cold end of the heat curve for condensing the CO₂ during the discharge operation will set the compressor suction pressure during the charge operation due to the heat integration between operating modes. The cold end of the heat curve requires a lower operating pressure during charge operation than the remainder of the curve. Thus, without the additional equipment of FIG. 14, only a relatively low suction pressure can be achieved with the first stage compressor and therefore a lower efficiency. By having two types of thermal storage 406B, 412B, the heat integration between charge and discharge operation can achieve a tighter temperature approach, and thus a higher suction pressure and higher efficiency can be achieved.

In view of the above, the concepts of the disclosure have a number of benefits and advantages relative to known technology. For example, the concepts of the disclosure contemplate condensing a low-pressure product to minimize storage volume and reduce unit plot size. The storage of high-pressure products or streams is accomplished via existing pipeline infrastructure, rather than with expensive standalone storage tanks or an underground cavern or other geological features. Such an arrangement eliminates geological requirements or one equipment service (which reduces plot size) and reduces cost. The technology described herein also does not rely on waste heat streams from other facilities, although if available, it may utilize them to improve efficiency of the system. This allows the systems to be located anywhere that has access to existing or new pipeline infrastructure. Another benefit is using CO₂ as the working fluid because it can be condensed at much more mild operating temperatures than other fluids that are commonly used for energy storage in known technologies. Condensing the CO₂ at low-pressure reduces the low-pressure storage volume, cost, and plot compared to storing the low-pressure product in vapor form.

Different configurations of the system may have different performance results with the system capable of being optimized to achieve different outcomes (i.e., higher efficiency, lower cost, etc.). A maximum energy density configuration has an energy density of 25.7 kW/m3 (at high-pressure conditions) and a round-trip efficiency between 40 and 50% depending on the configuration. In some implementations and configurations, the preliminary round trip efficiency for the discharge and charge operations is around 58.9% with a preliminary energy storage density (at low-pressure conditions) of 23.5 kW/m3 and preliminary energy storage density (at high-pressure conditions) of 17.4 kW/m3. Regardless of the configuration, the concepts of the disclosure provide for a significant improvement in efficiency and/or energy density relative to known technology.

Thus, in sum, an implementation of a system according to the present disclosure may be summarized as including: a discharge subsystem in fluid communication with an existing CO2 pipeline, the discharge subsystem including at least one expander stage and a low-pressure CO2 storage tank; a charge subsystem in fluid communication with the low-pressure CO₂ storage tank of the discharge subsystem and the existing CO₂ pipeline, the charge subsystem including at least one compressor stage, wherein the discharge subsystem is configured to receive a high-pressure CO2 stream from the existing CO₂ pipeline and the at least one expander stage is configured to expand the high-pressure CO₂ stream to generate power and produce a low-pressure CO₂ stream for storage in the low-pressure CO₂ storage tank, and wherein the charge subsystem is configured to receive the low-pressure CO₂ stream from the low-pressure CO₂ storage tank and the at least one compressor stage is configured to compress the low-pressure CO₂ stream to generate a recycle high-pressure CO₂ stream that is returned to the existing CO₂ pipeline.

In an implementation, the system further includes the at least one expander stage of the discharge subsystem including a first expander stage, a second expander stage, and a third expander stage.

In an implementation, the system further includes each of the first, second, and third expander stages including a turbo-expander configured to generate power and a heater.

In an implementation, the system further includes the discharge subsystem further including a dryer.

In an implementation, the system further includes the discharge subsystem further including a dryer regeneration subsystem in fluid communication with the dryer and a dryer regeneration gas cooler, the dryer regeneration gas cooler being between the first expansion stage and the second expansion stage.

In an implementation, the system further includes the dryer regeneration subsystem including a blower, an effluent exchanger, a heater, a further dryer, and the dryer regeneration gas cooler in a fluid loop with the dryer.

In an implementation, the system further includes the discharge subsystem including a thermal store in fluid communication with the third expander stage and the low-pressure CO2 storage tank, the thermal store configured to cool the low-pressure CO₂ stream from the third expander stage and provide a cooled low-pressure CO₂ stream for storage in the low-pressure CO2 storage tank.

In an implementation, the system further includes the discharge subsystem including a product chiller between the thermal store and the low-pressure CO₂ storage tank and a refrigerant package in fluid communication with the thermal store and the product chiller, the refrigerant package configured to provide a cooling effluent to the thermal store and the product chiller to assist in cooling the low-pressure CO₂ stream.

In an implementation, the system further includes the at least one compressor stage of the charge subsystem including a first compressor stage, a second compressor stage, and a third compressor stage.

In an implementation, the system further includes each of the first, second, and third compressor stages including a compressor and a cooler.

In an implementation, the system further includes the charge subsystem including a thermal store between the low-pressure CO₂ storage tank and the first compressor stage, the thermal store configured to vaporize the low-pressure CO₂ stream from the low-pressure CO₂ storage tank.

In an implementation, the system further includes the first, second, and third compressor stages being configured to compress and cool the low-pressure CO₂ stream to generate the recycle high-pressure CO₂ stream.

In an implementation, the system further includes a thermal integration subsystem in fluid communication with the at least one expander stage of the discharge subsystem and the at least one compressor stage of the charge subsystem, wherein the thermal integration subsystem includes a warm water storage tank and a cool water storage tank in a fluid loop with the at least one expander stage and the at least one compressor stage.

In an implementation, the system further includes the thermal integration subsystem further including a trim heater in fluid communication with the warm water storage tank in a warm water maintenance circuit of the fluid loop.

In an implementation, the system further includes the thermal integration subsystem further includes a trim cooler in fluid communication with the cool water storage tank in a cool water maintenance circuit of the fluid loop.

In an implementation, the system further includes the thermal integration subsystem further including a first pump configured to provide warm water from the warm water storage tank to the at least one expander stage of the discharge subsystem, and wherein cool water output by the at least one expander stage is returned to the cool water storage tank.

In an implementation, the system further includes the thermal integration subsystem further including a second pump configured to provide cool water from the cool water storage tank to the at least one compressor stage of the charge subsystem, and wherein warm water output by the at least one compressor stage is returned to the warm water storage tank to complete the fluid loop.

An implementation of a system may be summarized as including: a discharge subsystem operable to generate power from a high-pressure CO₂ stream from an existing CO2 pipeline, the discharge subsystem including: a first expander stage including a first heater and a first turbo-expander, wherein the first expander stage is configured to expand and heat the high-pressure CO₂ stream to form a first intermediate-pressure CO₂ stream, and wherein the first turbo-expander is configured to generate power based on a pressure differential between the high-pressure CO2 stream and the first intermediate-pressure CO₂ stream; a second expander stage including a second heater and a second turbo-expander, wherein the second expander stage is configured to expand and heat the first intermediate-pressure CO₂ stream to form a second intermediate-pressure CO₂ stream, and wherein the second turbo-expander is configured to generate power based on a pressure differential between the first intermediate-pressure CO₂ stream and the second intermediate-pressure CO₂ stream; a first dryer downstream of the second expander stage; a third expander stage downstream of the first dryer, the third expander stage including a third heater and a third turbo-expander, wherein the third expander stage is configured to expand and heat the second intermediate-pressure CO₂ stream to form a low-pressure CO₂ stream, and wherein the third turbo-expander is configured to generate power based on a pressure differential between the second intermediate-pressure CO₂ stream and the low-pressure CO₂ stream; a thermal store downstream of the third expander stage and including a phase change material configured to cool the low-pressure CO₂ stream and form a cooled low-pressure CO₂ stream; and a low-pressure CO₂ storage tank configured to receive and store the cooled low-pressure CO₂ stream; and a charge subsystem operable to compress the cooled low-pressure CO₂ stream to generate a recycle high-pressure CO2 stream that is returned to the existing CO₂ pipeline.

In an implementation, the system further includes the discharge subsystem further including a filter upstream of the first expander stage and a high-pressure knockout drum between the filter and the first expander stage, the filter configured to remove impurities from the high-pressure CO₂ stream and the high-pressure knockout drum configured to remove condensate from the high-pressure CO₂ stream.

In an implementation, the system further includes the discharge subsystem further including a dryer regenerator gas cooler downstream of the first expander stage.

In an implementation, the system further includes the discharge subsystem further including a dryer regeneration subsystem in communication with the dryer regenerator gas cooler.

In an implementation, the system further includes the dryer regeneration subsystem including an effluent exchanger, an electric heater, and a second dryer in communication with the dryer regenerator gas cooler in a fluid loop.

In an implementation, the system further includes the discharge subsystem further including a medium-pressure knockout drum between the second heater and the second turbo-expander of the second expander stage.

In an implementation, the system further includes the discharge subsystem further including a filter in communication with an outlet of the first dryer and configured to remove impurities from an effluent from the first dryer.

In an implementation, the system further includes the discharge subsystem further including: a CO₂ product chiller downstream of the thermal store and configured to cool the cooled low-pressure CO₂ stream and produce a further cooled low-pressure CO₂ stream provided to the low-pressure CO₂ storage tank; and a refrigerant section in fluid communication with the thermal store and the CO₂ product chiller and configured to provide a cooling stream to the CO₂ product chiller.

In an implementation, the system further includes a portion of the further cooled low-pressure CO₂ stream being recycled to the thermal store.

In an implementation, the system further includes the charge subsystem including a first compressor stage, a second compressor stage, and a third compressor stage, each of the first, second, and third compressor stages including a compressor and a cooler configured to sequentially compress and cool the cooled low-pressure CO₂ stream to generate the recycle high-pressure CO2 stream.

In an implementation, the system further includes the charge subsystem including a further thermal store upstream of the first compressor stage, the further thermal store configured to vaporize the cooled low-pressure CO₂ stream from the low-pressure CO₂ storage tank.

In an implementation, the system further includes a thermal integration subsystem in fluid communication with at least one the first, second, and third expander stages of the discharge subsystem and the charge subsystem, wherein the thermal integration subsystem includes a warm water storage tank and a cool water storage tank in a fluid loop with the at least one the first, second, and third expander stages of the discharge subsystem and the charge subsystem.

An implementation of a system may be summarized as including: a discharge subsystem operable to generate power from a high-pressure CO₂ stream from an existing CO2 pipeline and output a low-pressure CO₂ stream to a low-pressure storage tank; and a charge subsystem in fluid communication with the low-pressure storage tank, the charge subsystem operable to compress the low-pressure CO₂ and provide a recycle high-pressure CO₂ stream to the existing CO₂ pipeline, the charge subsystem including: a first compressor stage including a compressor and a cooler, wherein the first compressor stage is configured to compress and cool the low-pressure CO₂ stream from the low-pressure storage tank and output a first intermediate-pressure CO₂ stream; a second compressor stage including a compressor and a cooler, wherein the second compressor stage is configured to compress and cool the first intermediate-pressure CO₂ stream from the first compressor stage and output a second intermediate-pressure CO₂ stream; and a third compressor stage including a compressor and a cooler, wherein the third compressor stage is configured to compress and cool the second intermediate-pressure CO₂ stream from the second compressor stage and output the recycle high-pressure CO₂ stream to the existing pipeline.

In an implementation, the system further includes the charge subsystem further including a thermal store between the low-pressure CO₂ storage tank and the first compressor stage.

In an implementation, the system further includes the thermal store being configured to vaporize the low-pressure CO₂ stream from the low-pressure CO₂ storage tank and produce a vaporized low-pressure CO₂ stream.

In an implementation, the system further includes the charge subsystem including at least one suction drum between the thermal store and the first compressor stage, the at least one suction drum configured to separate liquid from the vaporized low-pressure CO₂ stream prior to the first compressor stage.

In an implementation, the system further includes the charge subsystem including at least one knockout drum configured to separate condensate from a process stream and return the condensate to the thermal store in a fluid loop.

In an implementation, the system further includes the charge subsystem including a product trim cooler downstream of the third compressor stage, the product trim cooler operable to further cool the recycle high-pressure CO₂ stream prior to return to the existing pipeline.

In an implementation, the system further includes the discharge subsystem further including a plurality of expander stages, each expander stage of the plurality of expander stages including a turbo-expander configured to generate power based on a pressure differential of an inlet and exit stream and a heater.

In an implementation, the system further includes a thermal integration subsystem in fluid communication with at least one discharge subsystem and the first, second, and third compression stages of the charge subsystem, wherein the thermal integration subsystem includes a warm water storage tank and a cool water storage tank in a fluid loop with the discharge subsystem and at least one the first, second, and third compression stages of the charge subsystem.

An implementation of a system may be summarized as including: a discharge subsystem including at least one expander stage and a low-pressure CO₂ storage tank, the at least one expander stage operable to generate power from a high-pressure CO₂ stream from an existing CO₂ pipeline and output a low-pressure CO₂ stream to the low-pressure CO₂ tank; a charge subsystem in fluid communication with the low-pressure CO₂ storage tank and including at least one compressor stage, the at least one compressor stage operable to compress the low-pressure CO2 stream and provide a recycle high-pressure CO₂ stream to the existing CO₂ pipeline; and a thermal integration subsystem including a warm water storage tank and a cool water storage tank in fluid communication with the at least one expander stage of the discharge subsystem and at the least one compression stage of the charge subsystem in a fluid loop.

In an implementation, the system further includes the thermal integration subsystem further including a pump, a trim heater, and a bypass in fluid communication with the warm water storage tank in a warm water maintenance circuit of the fluid loop.

In an implementation, the system further includes the thermal integration subsystem further including a pump, a trim cooler, and a bypass in fluid communication with the cool water storage tank in a cool water maintenance circuit of the fluid loop.

In an implementation, the system further includes the thermal integration subsystem further including a first pump in fluid communication with the warm water storage tank and a second pump in fluid communication with the cool water storage tank.

In an implementation, the system further includes the first pump being operable to provide warm water from the warm water storage tank to the at least one expander stage of the discharge subsystem, and wherein cool water output by the at least one expander stage of the discharge subsystem is provided to the cool water storage tank.

In an implementation, the system further includes the second pump being operable to provide cool water from the cool water storage tank to the at least one compression stage of the charge subsystem, and wherein warm water output by the at least one compression stage of the charge subsystem is provided to the warm water storage tank.

An implementation of a system may be summarized as including: a discharge subsystem configured to generate power from a high-pressure CO₂ stream of an existing CO2 pipeline and output a low-pressure CO₂ stream; and a charge subsystem configured to compress the low-pressure CO₂ stream from the discharge subsystem and provide a recycle high-pressure CO2 stream to the existing CO₂ pipeline, wherein the existing CO₂ pipeline is configured to provide storage of the of the high-pressure CO₂ stream during discharge and charge operations.

An implementation of a method may be summarized as including: storing high-pressure CO₂ in an existing pipeline; generating power from the high-pressure CO₂ from the existing pipeline; and providing a recycle high-pressure CO₂ stream to the existing pipeline.

An implementation of a system may be summarized as including: a discharge subsystem in fluid communication with a CO₂ pipeline, the discharge subsystem including at least one expander stage; a low-pressure CO₂ storage media in fluid communication with the discharge subsystem; a charge subsystem in fluid communication with the low-pressure CO₂ storage media and the CO₂ pipeline, the charge subsystem including at least one compressor stage, wherein the discharge subsystem is configured to receive a high-pressure CO₂ stream from the CO₂ pipeline and the at least one expander stage is configured to expand the high-pressure CO₂ stream to generate power and produce a low-pressure CO₂ stream for storage in the low-pressure CO₂ storage media, and wherein the charge subsystem is configured to receive the low-pressure CO₂ stream from the low-pressure CO₂ storage media and the at least one compressor stage is configured to compress the low-pressure CO₂ stream to generate a recycle high-pressure CO₂ stream that is returned to the CO2 pipeline.

In an implementation, the at least one expander stage of the discharge subsystem includes a turbo-expander configured to generate power.

In an implementation, the discharge subsystem includes at least one heater or at least one cooler upstream of the turbo-expander.

In an implementation, the discharge subsystem further includes a dryer.

In an implementation, the discharge subsystem further includes a dryer regeneration gas blower, the discharge subsystem further including a dryer regeneration subsystem in fluid communication with the dryer and the dryer regeneration gas blower.

In an implementation, the dryer regeneration subsystem includes an effluent exchanger, a heater, a further dryer, and the dryer regeneration gas blower in a fluid loop with the dryer.

In an implementation, the discharge subsystem includes a thermal store in fluid communication with the dryer and the low-pressure CO₂ storage media, the thermal store configured to condense the low-pressure CO₂ stream from the dryer and provide a cooled low-pressure CO2 stream for storage in the low-pressure CO₂ storage media.

In an implementation, the discharge subsystem includes a product chiller between the thermal store and the low-pressure CO₂ storage media and a refrigerant package in fluid communication with the thermal store and the product chiller, the refrigerant package configured to provide a cooling effluent to the thermal store and the product chiller to assist in cooling the low-pressure CO₂ stream.

In an implementation, the at least one compressor stage of the charge subsystem includes a first compressor stage and a second compressor stage.

In an implementation, each of the first and second compressor stages includes a compressor, and wherein at least one of the first and second compressor stages includes a cooler.

In an implementation, the charge subsystem includes a thermal store between the low-pressure CO₂ storage media and the first compressor stage, the thermal store configured to vaporize the low-pressure CO₂ stream from the low-pressure CO₂ storage media.

In an implementation, the first and second compressor stages are configured to compress and cool, at least in part, the low-pressure CO₂ stream to generate the recycle high-pressure CO₂ stream.

In an implementation, the system further includes: a thermal integration subsystem in fluid communication with the at least one expander stage of the discharge subsystem and the at least one compressor stage of the charge subsystem, wherein the thermal integration subsystem includes at least a heating duty storage tank and a cooling duty storage tank in a fluid loop with the at least one expander stage and the at least one compressor stage.

In an implementation, the thermal integration subsystem further includes a trim heater in fluid communication with the heating duty storage tank in a warm fluid maintenance circuit of the fluid loop.

In an implementation, the thermal integration subsystem further includes a trim cooler in fluid communication with the cooling duty storage tank in a cool fluid maintenance circuit of the fluid loop.

In an implementation, the thermal integration subsystem further includes a first pump configured to provide warm fluid from the heating duty storage tank to the at least one expander stage of the discharge subsystem, and wherein cool fluid output by the at least one expander stage is returned to the cooling duty storage tank.

In an implementation, the thermal integration subsystem further includes a second pump configured to provide cool fluid from the cooling duty storage tank to the at least one compressor stage of the charge subsystem, and wherein warm fluid output by the at least one compressor stage is returned to the heating duty storage tank to complete the fluid loop.

In an implementation, a system may be summarized as including: a discharge subsystem operable to generate power from a high-pressure CO₂ stream from a CO₂ pipeline, the discharge subsystem including an expander stage including a turbo-expander, wherein the expander stage is configured to expand and heat the high-pressure CO₂ stream to form a low-pressure CO2 stream, and wherein the turbo-expander is configured to generate power based on a pressure differential between the high-pressure CO₂ stream and the low-pressure CO₂ stream, a dryer downstream of the expander stage, a thermal store downstream of the expander stage, the thermal store configured to cool the low-pressure CO₂ stream and form a cooled low-pressure CO₂ stream, and a low-pressure CO₂ storage media configured to receive and store the cooled low-pressure CO2 stream; and a charge subsystem operable to compress the cooled low-pressure CO₂ stream to generate a recycle high-pressure CO₂ stream that is returned to the CO₂ pipeline.

In an implementation, the discharge subsystem further includes a filter upstream of the expander stage and a knockout drum between the filter and the expander stage, the filter configured to remove impurities from the high-pressure CO₂ stream and the knockout drum configured to remove condensate from the high-pressure CO₂ stream.

In an implementation, the discharge subsystem further includes a dryer regenerator gas blower downstream of the expander stage.

In an implementation, the discharge subsystem further includes a dryer regeneration subsystem in communication with the dryer regenerator gas blower.

In an implementation, the dryer regeneration subsystem includes an effluent exchanger, an electric heater, and a second dryer in communication with the dryer regenerator gas blower in a fluid loop.

In an implementation, the discharge subsystem further includes at least one heater or cooler upstream of the turbo-expander.

In an implementation, the discharge subsystem further includes a filter in communication with an outlet of the dryer and configured to remove impurities from an effluent from the dryer.

In an implementation, the discharge subsystem further includes: a CO₂ product chiller downstream of the thermal store and configured to cool the cooled low-pressure CO₂ stream and produce a further cooled low-pressure CO₂ stream provided to the low-pressure CO₂ storage media; and a refrigerant section in fluid communication with the thermal store and the CO₂ product chiller and configured to provide a cooling stream to at least one of the thermal store and the CO2 product chiller.

In an implementation, a portion of the further cooled low-pressure CO₂ stream is recycled to the thermal store.

In an implementation, the charge subsystem includes a first compressor stage and a second compressor stage, each of the first and second compressor stages including a compressor configured to sequentially compress the cooled low-pressure CO₂ stream to generate the recycle high-pressure CO₂ stream.

In an implementation, the charge subsystem includes at least one heater or cooler and a further thermal store in fluid communication with the at least one heater or cooler.

In an implementation, the system further comprising: a thermal integration subsystem in fluid communication with the expander stage of the discharge subsystem and the charge subsystem, wherein the thermal integration subsystem includes at least a warm fluid storage tank and a cool fluid storage tank in a fluid loop with the expander stage of the discharge subsystem and the charge subsystem.

In an implementation, a system may be summarized as including: a discharge subsystem operable to generate power from a high-pressure CO₂ stream from a CO₂ pipeline and output a low-pressure CO₂ stream to a low-pressure storage media; and a charge subsystem in fluid communication with the low-pressure storage media, the charge subsystem operable to compress the low-pressure CO₂ and provide a recycle high-pressure CO₂ stream to the CO₂ pipeline, the charge subsystem including a first compressor stage including a compressor and a cooler, wherein the first compressor stage is configured to compress and cool the low-pressure CO₂ stream from the low-pressure storage media and output an intermediate-pressure CO₂ stream, a second compressor stage including a compressor, wherein the second compressor stage is configured to compress and cool the intermediate-pressure CO₂ stream from the first compressor stage and output a high-pressure CO2 stream, and at least one cooler downstream of the second compressor stage, the at least one cooler configured to further cool the high-pressure CO₂ stream and output the recycle high-pressure CO2 stream to the CO₂ pipeline.

In an implementation, the charge subsystem further includes a thermal store between the low-pressure CO₂ storage media and the first compressor stage.

In an implementation, the thermal store is configured to vaporize the low-pressure CO₂ stream from the low-pressure CO₂ storage media and produce a vaporized low-pressure CO2 stream.

In an implementation, the charge subsystem includes at least one suction drum between the thermal store and the first compressor stage, the at least one suction drum configured to separate liquid from the vaporized low-pressure CO₂ stream prior to the first compressor stage.

In an implementation, the charge subsystem includes at least one separator configured to separate condensate from a process stream and return the condensate to the thermal store in a fluid loop.

In an implementation, the at least one cooler of the charge subsystem includes a first cooler stage and a second cooler stage, the first and second cooler stages operable to sequentially cool the high-pressure CO₂ stream to form the recycle high-pressure CO₂ stream.

In an implementation, the discharge subsystem further includes an expander stage including a turbo-expander configured to generate power based on a pressure differential of an inlet and exit stream.

In an implementation, the system further includes: a thermal integration subsystem in fluid communication with the discharge subsystem and the charge subsystem, wherein the thermal integration subsystem includes a warm fluid storage tank and a cool fluid storage tank in a fluid loop with the discharge subsystem and the charge subsystem.

In an implementation, a system may be summarized as including: a discharge subsystem including at least one expander stage and a low-pressure CO₂ storage media, the at least one expander stage operable to generate power from a high-pressure CO₂ stream from an CO2 pipeline and output a low-pressure CO₂ stream to the low-pressure CO₂ media; a charge subsystem in fluid communication with the low-pressure CO₂ storage media and including at least one compressor stage, the at least one compressor stage operable to compress the low-pressure CO2 stream and provide a recycle high-pressure CO₂ stream to the CO₂ pipeline; and a thermal integration subsystem including at least a warm fluid storage tank and a cool fluid storage tank in fluid communication with the at least one expander stage of the discharge subsystem and the at the least one compression stage of the charge subsystem in a fluid loop.

In an implementation, the thermal integration subsystem further includes a pump, a trim heater, and a bypass in fluid communication with the warm fluid storage tank in a warm fluid maintenance circuit of the fluid loop.

In an implementation, the thermal integration subsystem further includes a pump, a trim cooler, and a bypass in fluid communication with the cool fluid storage tank in a cool fluid maintenance circuit of the fluid loop.

In an implementation, the thermal integration subsystem further includes a first pump in fluid communication with the warm fluid storage tank and a second pump in fluid communication with the cool fluid storage tank.

In an implementation, the first pump is operable to provide warm fluid from the warm water storage tank to the at least one expander stage of the discharge subsystem, and wherein cool fluid output by the at least one expander stage of the discharge subsystem is provided to the cool fluid storage tank.

In an implementation, the second pump is operable to provide cool fluid from the cool fluid storage tank to the at least one compression stage of the charge subsystem, and wherein warm fluid output by the at least one compression stage of the charge subsystem is provided to the warm fluid storage tank.

Related methods to the above and other implementations described herein are also contemplated.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied outside of the energy storage context, and are not limited to the example energy storage systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various implementations of the disclosure. However, one skilled in the art will understand that the disclosure may be practiced without these specific details. In other instances, well-known structures associated with heat recovery and heat exchanger devices, systems, and methods have not been described in detail to avoid unnecessarily obscuring the descriptions of the implementations of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a shell may refer to one shell. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one implementation,” “in another implementation,” “in various implementations,” “in some implementations,” “in other implementations,” and other derivatives thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise.

Generally, unless otherwise indicated, the materials for making the invention and/or its components may be selected from appropriate materials such as composite materials, ceramics, plastics, metal, polymers, thermoplastics, elastomers, plastic compounds, and the like, either alone or in any combination.

The foregoing description, for purposes of explanation, uses specific nomenclature and formula to provide a thorough understanding of the disclosed implementations. It should be apparent to those of skill in the art that the specific details are not required in order to practice the invention. The implementations have been chosen and described to best explain the principles of the disclosed implementations and its practical application, thereby enabling others of skill in the art to utilize the disclosed implementations, and various implementations with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the implementations of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various implementations described herein, and as such, it is expressly contemplated in the present disclosure to include dimensions that are more or less than the dimensions stated, unless the context clearly dictates otherwise.

The present application claims the benefit of and priority to U.S. Provisional Patent Application No. 63/518,494, filed Aug. 9, 2023, the entire contents of which are incorporated herein by reference.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the breadth and scope of a disclosed implementation should not be limited by any of the above-described implementations, but should be defined only in accordance with the following claims and their equivalents.

1. A system, comprising:
a discharge subsystem in fluid communication with a CO₂ pipeline, the discharge subsystem including at least one expander stage;
a low-pressure CO₂ storage media in fluid communication with the discharge subsystem;
a charge subsystem in fluid communication with the low-pressure CO₂ storage media and the CO₂ pipeline, the charge subsystem including at least one compressor stage, wherein the discharge subsystem is configured to receive a high-pressure CO₂ stream from the CO₂ pipeline and the at least one expander stage is configured to expand the high-pressure CO2 stream to generate power and produce a low-pressure CO₂ stream for storage in the low-pressure CO₂ storage media, and
wherein the charge subsystem is configured to receive the low-pressure CO₂ stream from the low-pressure CO₂ storage media and the at least one compressor stage is configured to compress the low-pressure CO₂ stream to generate a recycle high-pressure CO₂ stream that is returned to the CO2 pipeline.

2. The system of claim 1, wherein the at least one expander stage includes a turbo-expander configured to generate power based on a pressure differential between the high-pressure CO₂ stream and the low-pressure CO₂ stream, and
wherein the discharge subsystem further includes a dryer and at least one heater or at least one cooler.

3. The system of claim 2, wherein the discharge subsystem further includes a dryer regeneration gas blower in communication with the dryer, the discharge subsystem further including a dryer regeneration subsystem in fluid communication with the dryer and the dryer regeneration gas blower.

4. The system of claim 3, wherein the dryer regeneration subsystem includes an effluent exchanger, a heater, a further dryer, and the dryer regeneration gas blower in a fluid loop with the dryer.

5. The system of claim 2, wherein the discharge subsystem includes a thermal store in fluid communication with the dryer and the low-pressure CO₂ storage media, the thermal store configured to condense the low-pressure CO₂ stream from the dryer and provide a cooled low-pressure CO₂ stream for storage in the low-pressure CO₂ storage media.

6. The system of claim 5, wherein the charge subsystem includes a first compressor stage, and
wherein the thermal store is between the low-pressure CO₂ storage media and the first compressor stage, the thermal store further configured to vaporize the low-pressure CO₂ stream from the low-pressure CO₂ storage media and provide vaporized low-pressure CO₂ to the first compressor stage.

7. The system of claim 1, further comprising:
a thermal integration subsystem in fluid communication with the at least one expander stage of the discharge subsystem and the at least one compressor stage of the charge subsystem, wherein the thermal integration subsystem includes at least a heating duty storage tank and a cooling duty storage tank in a fluid loop with the at least one expander stage and the at least one compressor stage.

8. A system, comprising:
a discharge subsystem operable to generate power from a high-pressure CO₂ stream from a CO₂ pipeline, the discharge subsystem including:
an expander stage including a turbo-expander, wherein the expander stage is configured to expand and heat the high-pressure CO₂ stream to form a low-pressure CO₂ stream, and wherein the turbo-expander is configured to generate power based on a pressure differential between the high-pressure CO₂ stream and the low-pressure CO₂ stream;
a dryer downstream of the expander stage;
a thermal store downstream of the expander stage, the thermal store configured to cool the low-pressure CO₂ stream and form a cooled low-pressure CO₂ stream; and
a low-pressure CO₂ storage media configured to receive and store the cooled low-pressure CO₂ stream; and
a charge subsystem operable to compress the cooled low-pressure CO₂ stream to generate a recycle high-pressure CO₂ stream that is returned to the CO₂ pipeline.

9. The system of claim 8, wherein the discharge subsystem further includes a filter upstream of the expander stage and a knockout drum between the filter and the expander stage, the filter configured to remove impurities from the high-pressure CO₂ stream and the knockout drum configured to remove condensate from the high-pressure CO₂ stream.

10. The system of claim 8, wherein the discharge subsystem further includes a dryer regenerator gas blower and a dryer regeneration subsystem in communication with the dryer regenerator gas blower.

11. The system of claim 8, wherein the discharge subsystem further includes at least one heater or cooler upstream of the turbo-expander.

12. The system of claim 8, wherein the charge subsystem includes a first compressor stage and a second compressor stage, each of the first and second compressor stages including a compressor configured to sequentially compress the cooled low-pressure CO₂ stream to generate the recycle high-pressure CO₂ stream.

13. The system of claim 12, wherein the charge subsystem includes at least one heater or cooler downstream of the second compressor stage.

14. The system of claim 8, further comprising:
a thermal integration subsystem in fluid communication with the expander stage of the discharge subsystem and the charge subsystem, wherein the thermal integration subsystem includes at least a warm fluid storage tank and a cool fluid storage tank in a fluid loop with the expander stage of the discharge subsystem and the charge subsystem.

15. A system, comprising:
a discharge subsystem operable to generate power from a high-pressure CO₂ stream from a CO₂ pipeline and output a low-pressure CO₂ stream to a low-pressure storage media; and
a charge subsystem in fluid communication with the low-pressure storage media, the charge subsystem operable to compress the low-pressure CO₂ and provide a recycle high-pressure CO2 stream to the CO₂ pipeline, the charge subsystem including:
a first compressor stage including a compressor and a cooler, wherein the first compressor stage is configured to compress and cool the low-pressure CO₂ stream from the low-pressure storage media and output an intermediate-pressure CO₂ stream;
a second compressor stage including a compressor, wherein the second compressor stage is configured to compress the intermediate-pressure CO₂ stream from the first compressor stage and output a high-pressure CO₂ stream; and
at least one cooler downstream of the second compressor stage, the at least one cooler configured to further cool the high-pressure CO₂ stream and output the recycle high-pressure CO2 stream to the CO₂ pipeline.

16. The system of claim 15, wherein the charge subsystem further includes a thermal store between the low-pressure CO₂ storage media and the first compressor stage,
wherein the thermal store is configured to vaporize the low-pressure CO₂ stream from the low-pressure CO₂ storage media and produce a vaporized low-pressure CO₂ stream.

17. The system of claim 16, wherein the charge subsystem includes at least one suction drum between the thermal store and the first compressor stage, the at least one suction drum configured to separate liquid from the vaporized low-pressure CO₂ stream prior to the first compressor stage.

18. The system of claim 16, wherein the charge subsystem includes at least one separator configured to separate condensate from a process stream and return the condensate to the thermal store in a fluid loop.

19. The system of claim 15, wherein the at least one cooler of the charge subsystem includes a first cooler stage and a second cooler stage, the first and second cooler stages operable to sequentially cool the high-pressure CO₂ stream to form the recycle high-pressure CO₂ stream.

20. The system of claim 15, further comprising:
a thermal integration subsystem in fluid communication with the discharge subsystem and the charge subsystem, wherein the thermal integration subsystem includes a warm fluid storage tank and a cool fluid storage tank in a fluid loop with the discharge subsystem and the charge subsystem.
